(19) United States
(12) Patent Application Publication
(10) Pub. No.: US 2006/0168006 A1
(43) Pub. Date: Jul. 27, 2006

(54) System and method for the classification of electronic communication

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Mr. Marvin Shannon, Pasadena, CA (US); Dr. Wesley Boudville, Perth (AU)

(21) Appl. No.: 10/708,757

(22) Filed: Mar. 24, 2004

Related U.S. Application Data
(60) Provisional application No. 60/320,046, filed on Mar. 24, 2003.
(60) Provisional application No. 60/481,789, filed on Dec. 14, 2003.
(60) Provisional application No. 60/481,899, filed on Jan. 15, 2004.
(60) Provisional application No. 60/521,174, filed on Mar. 3, 2004.

(51) Int. Cl. G06F 15/16

(52) U.S. Cl. 709/206

(57) ABSTRACT

From an electronic message, we extract any destinations in selectable links, and we reduce the message to a “canonical” (standard) form that we define. It minimizes the possible variability that a spammer can introduce, to produce unique copies of a message. We then make multiple hashes. These can be compared with those from messages received by different users to objectively find bulk messages. From these, we build hash tables of bulk messages and make a list of destinations from the most frequent messages. The destinations can be used in a Real time Blacklist (RBL) against links in bodies of messages. Similarly, the hash tables can be used to identify other messages as bulk or spam. Our method can be used by a message provider or group of users (where the group can do so in a p2p fashion) independently of whether any other provider or group does so. Each user can maintain a “gray list” of bulk mail senders that she subscribes to, to distinguish between wanted bulk mail and unwanted bulk mail (spam). The gray list can be used instead of a whitelist, and is far easier for the user to maintain.

### CROSS REFERENCE TO RELATED APPLICATIONS

This application claims the benefit of the filing date of U.S. Provisional Application, No. 60/320,046, “System and Method for the Classification of Electronic Communications”, filed Mar. 24, 2003, and U.S. Provisional Application, No. 60/481,789, “System and Method for the Algorithmic Disposition of Electronic Communications”, filed Dec. 14, 2003, and U.S. Provisional Application, No. 60/481,899, “Systems and Method for Advanced Statistical Categorization of Electronic Communications”, filed Jan. 15, 2004, and U.S. Provisional Application, No. 60/521,174, “System and Method for Finding and Using Styles in Electronic Communications”, filed Mar. 3, 2004. Each of these applications is incorporated by reference in its entirety.

### BACKGROUND OF INVENTION

1. Technical Field

This invention relates generally to information delivery and management in a computer network. More particularly, the invention relates to techniques for automatically classifying electronic communications as bulk versus non-bulk and categorizing the same.

### BACKGROUND OF THE INVENTION

There exists a large body of anti-spam techniques and technologies in the marketplace today.

All are useful to some extent, but all existing techniques/technologies have major deficiencies that we address in our system.

Below is a sampling of the current anti-spam technologies and the issues surrounding their effectiveness.

Bayesian Classification

A user can read through her email and mark certain messages as spam. Bayesian filtering can then be applied to the spam and non spam messages, to learn the characteristics of email and make a decision based on probabilistic distribution of past common characteristics.

Current Bayesian filters and classification systems are prone to a couple of issues that restrict their usefulness.

1. These filters do not work well without a large sample set of positive and negative training examples.

2. They can be “poisoned” by the inclusion of common words in the negative training set. The amount of effort required to maintain the filter becomes unmanageable over time.

Textual Analysis

Textual analysis identifies messages as containing words, word combinations, or word/sentence/paragraph structures that are categorized by an attendant rule-set. It can be divided into the following categories:

1. Keyword Analysis

Identifying keywords in the material is the most usual usage of textual analysis. These methodologies look at the words to determine the “category” of the content in the message.

2. Offensive Content Identification [Keyword Blocking]

Identifying offensive material is a common form of textual analysis. Offensive material analysis identifies Spam that is of adult nature. Due to the liability of offensive material in the work place, more aggressive actions can be applied to the messages identified as adult in nature.

3. Machine Learning Techniques

Identifying offensive material by looking at words, word arrangements, patterns of word/sentence arrangements (arcs), etc. Could be considered to be a keyword blocker on steroids.

Textual analysis is an open ended, computationally difficult problem. A user, administrator or outside expert must identify all possible words and/or combinations of words to be blocked.

Creation of this rule set is extremely time consuming, and can never be considered complete. Often the rules are ambiguous, leading to many falsely identified emails. Sometimes the rules have unintended consequences that are devastating, such as the exclusion of all email.

Intent Based Filtering

Utilizes Artificial Intelligence to (try to) determine the “intent” of the email regardless of the occurrences of particular words that might otherwise trigger a content analysis filter. These filters use Natural Language Processing (NLP) to attempt to determine the meaning of specific communications. The accuracy of Natural Language Processing is highly context dependent leading to the requirement of continual refinement of the language model rule set. Intent Based Filtering is an unbounded computational problem. As the number and complexity of rules increases, the time required to filter communications can rapidly become unacceptable.

Spam Signatures

Spam definitions are patterns used to identify specific categories of spam based on their characteristics. They detect the category and then if considered sufficiently similar to be the same message (polymorphic spam) it is identified as spam.

Current spam signature methods use simplistic Bayesian, word frequency, and hash value tests to identify spam via its characteristics. These simple signature methods are poor at identifying spam. Mostly, due to the fact that they indiscriminately look at all data in the email and fail to deal with large scale variation within the communications envelope.

Heuristic Analysis

Heuristic analysis uses a series of internal tests to determine the likelihood that a message is spam. Each test is weighted with a point value to reduce false positives. The total probability of Spam is examined to determine an overall score, and a mapping function assigns the appropriate action. Actions include: rejecting, redirecting or tagging offending messages.

Current Heuristic analysis techniques fail due to inability to determine a proper input data set. These techniques also lack of the broader view of communications; the techniques are applied to individual communications without looking at the group meta-characteristics of the message.

Whitelists

A whitelist (that belongs to a user) is a list of senders that the user is willing to accept messages from. There are two typical ways to use a whitelist: require that the sender be listed to allow receipt of a message from the sender; or merely let listed senders be exempt from anti-spam processing.

Maintaining an explicit sender whitelist can be very difficult. If you typically receive emails at random time intervals (possibly months or years) from a large pools of people, an explicit whitelist that must include all authorized senders can be unmanageable.

Maintaining an anti-spam processing whitelist is easier as you can either add senders explicitly, or add them implicitly when you send someone email. Users can simply forward a message to the email management system to be included on the whitelist. Administrators can configure the list to recognize mailing list traffic and opt-in marketing messages that may otherwise be identified as Spam.

Unfortunately, it is highly likely you will lose email from first time senders in either case, if you rely solely on whitelists to manage spam.

Blacklists

A Blacklist is a list of email senders that are not allowed to send messages into your domain. ISPs can have a policy that allows the delivery of this content, if and only if, this sender exists in a user's whitelist.

Blacklists can be overly broad, and unintentionally punitive; leading to the exclusion of large numbers of legitimate email. If the list is compiled and maintained by a third party, then it will need to be carefully reviewed to prevent the exclusion of the users specific sender relationships.

Challenge Response

Challenge Response systems are sometimes described as Puzzle Solution. The idea is to present a challenge to a sender the first time that she transmits a message into your domain. The message is kept in escrow until a successful response has been made. If no response or no successful response has been received within some time interval, the original message may be discarded or returned to the sender.

Some systems require a new challenge response if certain behaviors are observed for a given sender, For example, sending multiple responses to a single email. The challenges can be as simple as a response email, or may include a visual or mathematical puzzle.

Challenge Response systems are considered offensive to a sizable segment of email users, and they ignore correspondences that require them.

These systems are a bane to legitimate mailing lists, and newsletters as they have no method for responding to them. Worse though, is that virtually all challenge response system are susceptible to gaming. Thus limiting their utility.

Sender Permitted From (SPF)

DNS verification that checks if the sender is using a valid mail server authorized by the emitting domain. Allows mail gateways to stop spammers from setting up their own mail servers, but does nothing to curb virally emitted spam coming from machines that have been taken over by a virus.

Unfortunately, SPF requires that all Network Service Providers (NSPs) and Internet Service Providers (ISPs) implement it, and that these providers not let spammers operate on their networks. Given the financial incentives some providers have to work with bulk senders, this is a hard hurdle to clear.

Auto Updating Database

Local or remote spam blocking database based on thousands of Spam collecting bots, probe accounts, and web crawlers.

Current Auto Updating Database techniques are ineffective due to serious concerns relating to the quality of the material “identified” as spam. There also exists a lack of scope of the material collected versus the body of spam emitted daily; as well as the timeliness of the collection and updating processes, because spam changes rapidly. By the time that these databases are built, they are generally out of date.

Real Time Black List

The Real Time Black List (RBL) is a compilation of networks that either let spammers use their systems to send spam, or have not taken action to prevent spammers from abusing their systems. Mail relays check a message's purported sender domain against the RBL to determine if the sender's computer has been identified as a computer used by spammers.

RBLs are the most extreme type of blacklist. They are compiled by third parties with few if any checks or balances. Invariably, RBLs need extensive manual editing, validation and management to be useful. In part because spammers will attempt to nominate non-spamming domains to the list, in order to discredit it. Unfortunately, it is difficult for an individual user or company to maintain a list of this size alone. And the rapidity with which spammers move their operations to new domains makes the list always just slightly out of date.

Outsourced Anti-Spam Solutions

Outsourced anti-spam solutions offer organizations a “managed service” that offloads the problem of spam fighting to an external third party. These solutions work by redirecting the organization's inbound e-mail stream to the third-party outsourcer. The outsourcer filters spam out of the e-mail stream, and then passes the remaining e-mail on to the organization for standard delivery through their e-mail relay, corporate mail servers, and finally down to desktops.

Outsourced solutions, as with other centrally managed solutions, are effective in reducing spam volume and thereby improving end-user productivity. Note that a number of the outsourced anti-spam solutions are used by major ISPs. Their customers benefit because the outsourcers have developed a strong understanding of consumer-targeted spam. The downside is that the public nature of these services lets spammers freely experiment against the spam filters. For this reason, some outsourced services have lower spam capture rates.

Like gateway-based solutions, they eliminate all network resource costs associated with spam, because they filter spam before it enters the corporate network. And because the system administration work is done externally, IT resource requirements are relatively low.

However, giving up this control is often a difficult challenge for larger organizations with more mission-critical security and uptime requirements. Also, because all of the organization's email is routed through a third party, outsourced anti-spam solutions can present a significant problem in industries with email security issues, such as financial services organizations that handle sensitive customer financial information and healthcare providers and payers who must comply with U.S. Health and Human Services HIPAA privacy and security regulations.

Organizations are also exposed to some risk in terms of the unknown reliability of the outsourcer's system. If it goes down, the customer's email stops in its tracks. Even aside from this, there is a time lag required by the outsourcer's processing that may be unacceptable for urgently expected mail.

And while these solutions do not require additional hardware, software or administration, it is industry practice to price these costs into the service fees. While the price for one year of service might appear attractive over the short term, over a three-year payback period these costs often exceed those of hosting anti-spam solutions in-house.

Large organizations that rely on e-mail as a business-critical resource should weigh the risks of this approach against the longer-term value of owning and controlling their own anti-spam resources.

While the above-described techniques do minimize the harmful effects of spam, they require complex and costly software and/or servers that are difficult to set up and maintain. There remains a need for a simple, yet effective way of restricting unsolicited e-mail within an enterprise e-mail environment. The present invention addresses this need.

### SUMMARY OF INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

The present invention is directed to a method of processing electronic messages, to find bulk messages, and specifically those that are bulk and unwanted, commonly called spam. The method can be applied by a message provider, like an Internet Service Provider, or a company that runs an email server, to the messages received by the provider's users. In general, it can be applied by a provider of any type of electronic messages, including, but not limited to, email, instant messaging (IM), short message systems (SMS), text pagers and junk faxes. The method can also be applied by a group of users that are spread out over one or more message providers, where the users might implement the method by interacting in a peer-to-peer (p2p) fashion.

From a message, we extract several types of data. We find any domains in clickable links in the message body. We also apply a sequence of operations to remove possible sources of variability in the body, where these can be used by a spammer to generate many unique copies of a message. Most importantly, if there are any HTML tags, we optionally but preferably remove these. We call these steps canonical, for they operate to convert the body into a standard form. During these steps, we also look for the presence of various characteristics of the original message, and we call these styles. Multiple hashes are made from the resultant canonical text. By making more than one hash per message, we can now look for and measure similarities between messages.

We gather the domains, styles and hashes into what we call a Bulk Message Envelope (BME). The BME can also have information from the message header. This information can include relays through which the message purportedly passed. It can also include addresses of others to which the message was sent, plus the purported address of the sender. It can also include the subject of the message.

The hashes from a set of messages can be compared to see if any messages are canonically identical (have the same hashes) or similar (have a minimum number of same hashes). Users can exchange hashes to find out how many others have received the same (i.e. canonically identical) messages. This can be done in a p2p fashion, without the users needing to exchange the messages themselves. The hash comparisons can also be done by the message provider for its users.

Bulk mail can be objectively identified. The use of BMEs lets us find templates, which are groups of messages that variants of a common subset of text. We can then find associations between the extracted spammer domains, and group spammers according to these. From the bulk mail, we can find the most frequent instances and let individual users, or a group of users, or a provider, mark these as spam. In doing so, we can built tables of hashes of spam messages, and a list of spam domains and a list of associated styles, from those messages. The domain list can be used as a Real time Blacklist (RBL), where, unlike other methods, we apply this against domains found in the bodies of messages. The styles can also be used as an extra optional filter.

Bulk mail consists of spam and newsletters. Since we can find bulk mail, our method allows the use of a “gray list” by each user. It is a list of newsletters that she subscribes to. Hence, for a user's messages, since we can find the bulk mail within these, and now the user tells us which are the desired newsletters, we can identify spam, customized to her preferences. The user now does not, optionally, need to maintain a whitelist of all her correspondents, which is typically a far larger list than that of desired newsletters.

Our invention can be used by a message provider, independently of whether any other provider does so. That is, it can be deployed incrementally. There is no need for a change to another of the existing Internet standards or email protocols.

### BRIEF DESCRIPTION OF DRAWINGS

FIG. 1 is a flow chart of the method of the present invention as practiced in an ECM network.

FIG. 2 is a schematic flow chart of the method of the present invention.

FIG. 3 is an example of adaptive hashing techniques and terminology.

### DETAILED DESCRIPTION

### DETAILED DESCRIPTION OF THE PREFERRED EMBODIMENT

What we claim as new and desire to secure by letters patent is set forth in the following claims.

We define Electronic Communications Modality (ECM), in this context as referring to any means or process of digital communications that can be achieved, assisted, or enhanced by means of digital messages using a communications protocol appropriate to the particular communications modality.

ECM service, in this context, is meant to refer to some embodiment of software and/or hardware machine that permits for the exchange of digital messages using a communications protocol appropriate to the ECM; and optionally log information regarding the machine's execution.

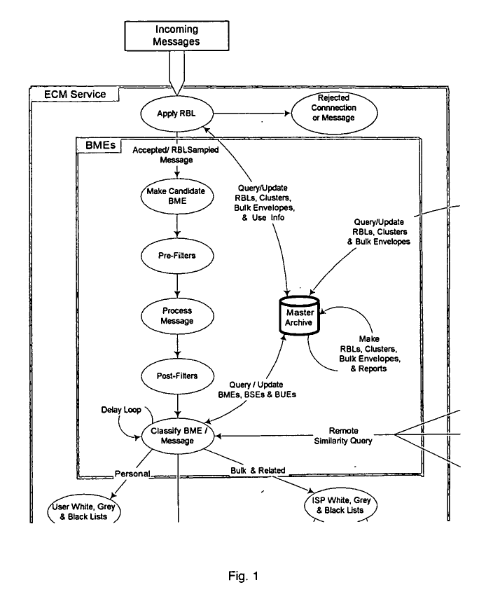

The present invention comprises an ECM service, as shown in FIG. 1, that can connect to other ECM services via appropriate communications protocols for the exchange of electronic messages. Some ECMs and/or ECM services may require establishment of a connection prior to message exchange. This view of ECM services is inherently symmetric with respect to the ECM. For example, this lets the same service model exist between an email server receiving messages from another e-mail gateway (e-mail server or e-mail relay), and between an email server receiving messages from a desk top email client application. As such, this ECM service model allows for receiver side and sender side (bi-directional) communications squelching for any ECM that can use a Real time Black List (RBL).

An ECM service may use an RBL, possibly in conjunction with a set of Exception Handling Rules or Procedures (EHRs), to implement an Exception Handing Process (EHP). RBLs in this context may include, but are not limited to, any combination of the following elements:

1. Internet Protocol (IP) addresses

2. Groups or Ranges of IP addresses

3. Host or Domain names

4. Usernames/user addresses

5. Groups of Usernames/user addresses

6. Classification data on 1-5

7. Categorization date on 1-5

8. Relationship data on 1-5

9. Bulk Envelope data on 1-5

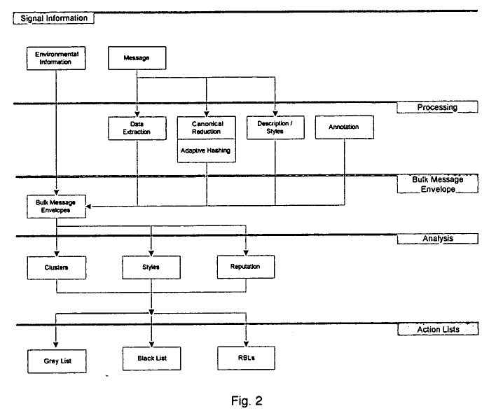

An ECM service may choose various handling options for message exchanges, and connection requests if applicable, from other ECM services based on the EHRs and the RBL, if either or both are present. One of the more common EHPs is communications blocking, but any handling procedure available to the particular ECM and/or ECM service is also available. One example would be message logging or connection redirection in an HTTP server The primary function of an ECM service is to manage message exchanges in an appropriate fashion. To this end, an ECM service may, taking into account existing EHRs and/or RBLs, choose to Accept or Reject any connection attempt; and/or Accept or Reject and/or Sample any message. In addition, an ECM service may take into account any sources of information directly and/or indirectly available, observable, and/or derivable, as shown in FIG. 2, to facilitate the management of message exchanges.

An ECM service may collect various Message Environment Information (MEI) relevant to the particular ECM for any connection attempt and/or message.

When an ECM service Accepts a message, or processes a message as a Reject-Sample, the service creates a Candidate Bulk Message Envelope (C-BME) with the message as the only member, and associates the C-BME with the appropriate MEI elements.

In advance of message processing an ECM service may execute, any number of and any combination of, a variety of filters (optionally linked to EHRs) to assist in the classification of a message and its properties. Filter types may include, but are not limited to, Bayesian Filters, General Statistical Filters, Content Filters, Contextual Filters, and/or Heuristic Properties (Styles) Filters. The filter results, including any resultant classification information and/or categorization information are derived from the message and/or C-BME properties.

An ECM service may process the message. A message may have different components including, but not limited to, any combination of a structured header, a structured body, an unstructured body, self-descriptive data such as XML, and/or self structured data such as a programming or scripting language.

An ECM service may extract addresses and various heuristics (which we call “Styles”) for use in analytical processes. Addresses, in this context, are taken to mean all electronic links, names and/or identifiers. This could include, but is not limited to, an IP address of a connecting ECM service, any routing identifiers or tokens in the header or body, and any electronic, and any linking or electronic connection information in the body (http links, ftp links, phone numbers, etc.).

In processing a message, an ECM service may use any number and combination of analytical processes including, but not limited to, Bayesian Analysis, General Statistical Analysis, Content Analysis, Contextual Analysis, and/or Style Analysis.

If the message has a message body, or payload, after the removal of header information related to the ECM, then the body may be canonically reduced and hashed into sets of canonical identifying codes (Canonical Hashes). (The hashing may be via adaptive hashing, as described in section 11.) Ideally, these codes are anonymized and sufficiently unique as to preclude degeneracy of sample to identifying code mappings (we would prefer a one-to-one relationship). In our preferred embodiment we use Hash codes (SHA-1 or SHA-2), although other identifying codes could be used as long as they meet the criteria set out above.

After message processing, an ECM service may execute any number of and any combination of, a variety of filters (optionally linked to EHRs) to assist in the classification of a message and its properties. Filter types may include, but are not limited to, Bayesian Filters, General Statistical Filters, Content Filters, Contextual Filters, and/or Heuristic Properties (Styles) Filters. The filter results, including any resultant classification information and/or categorization information, are derived from the message and/or C-BME properties.

An ECM service may use any combination of C-BME elements, message header elements, message body elements, Canonical Hashes, classification information, categorization information, Styles, and/or analytical convolutions or comparisons therein to reach a Final Classification of the C-BME.

One important measure of particular utility is the similarity relationships between the message, and/or C-BME, with existing BMEs; both locally and/or with remote ECM service peers and/or with remote ECM service “super-peers” (peers that aggregate BME information from other ECM services).

Remote comparison is possible in a completely anonymous, privacy-conserving process using the exchange of anonymous hashes for comparison with ECM service peer and super-peers, as described in section 4.2.4. This allows the determination of the shared existence of a Canonical Hash between two or more ECM services. This in turn allows the determination of the message multiplicity in the greater ECM environment without exchanging potentially private data. Additionally, the exchange may implement an anonymized verification procedure using Canonical sub-Hashes of the original Canonical data subset that generated the Canonical Hash in question, in conjunction with an offset and processing policy, to generate a verifiable sub-Hash. Then “similarity” of two or more messages and/or BMEs can be determined by the percentage of overlapping, optionally verified, Canonical Hashes; and the observed message/BME multiplicity can be derived for the local system, and ECM service peer/super-peers.

These anonymous hash query algorithms implement a general query/reply architecture that can be used for all of the usual database query/reply, and/or comparison procedures, without exposing the query data except to other holders of the same data.

An ECM service may then classify a C-BME and/or message resultant on all of the foregoing operations, results, and/or data (taking into account any EHRs).

An ECM service may then choose to do one of the following operations:

1. Merge the C-BME into an existing BME, if it meets similarity and multiplicity thresholds (taking into account any applicable EHRs). Apply local ECM service RBLs, and optionally Recipient RBL, (taking into account any applicable EHRs) to determine final disposition of message.

2. Promote the C-BME to full BME status. Optionally, place the BME into a Delay Loop queue for some period of time, to allow for new C-BME and/or messages to be potentially matched against the BME before final disposition. If the BME times out (or exits the Delay Loop queue due to EHPs), then apply Recipient RBL (if existent) and optionally local ECM service RBLs (taking into account any applicable EHRs) to determine final disposition of message.

3. Dispose of Reject-Sampled messages in accordance with any applicable EHRs.

An ECM services final disposition states (taking into account any applicable EHRs) includes, but is not necessarily limited to:

3.1. Accept the message for further action as applicable to the specific ECM.

3.2. Reject the message.

An ECM service may also performs some number of associated actions not described in the foregoing; potentially including, but not limited to:

1. Update the ECM service's RBL, BME, and associated data.

2. Listen for comparison requests from ECM Peers.

3. Listen for RBL, BME, and associated data update requests, where such data will be used in a manner appropriate to that ECM, ECM service, or other process.

4. Make requests for RBL, BME, and associated data update request to ECM services and/or other processes, where such data will be used in a manner appropriate to this ECM.

5. Generate various reports and processes We describe a way to use a peer-to-peer (p2p) architecture (with super-peers) to enable a blind classification or evaluation of received data. As an important instance, we include the case where the super-peer can be an aggregator of incoming and outgoing messages, and other peers interacting with the super-peer could be users reading messages sent to them (incoming), and sending outgoing messages. In this case, we will refer to the super-peer simply as a message provider.

Our methods are useful in, but not limited to, the following markets, or Electronic Communications Modalities (ECM) spaces: Email, universal inboxes, instant messaging (IM) and IM-like services.

Removal of junk communications received from users, where these users might be external or internal, relative to the group of p2p users or the group of users serviced by the message provider.

Blocking transmission of junk materials at the communications gateway interface.

Short Message Services (SMS) and Text Pagers.

Blocking transmission of junk materials before they are sent to the user.

Identify and eliminate junk faxes in digital fax systems and universal mailboxes.

Identifying link farms, which are used to skew search engine results.

Other Equivalent Information Systems.

Our methods use a p2p system architecture, or, alternatively, the methods can be implemented at a message provider, that enables the blind comparison of messages received by various individual users, to facilitate the classification of those messages. The more users that receive an identical or similar message, the greater the chance that the message can be independently classified and that these classifications be propagated to other users via a p2p system, or that the message provider can use these classifications for the benefit of all of its users. The messages that are classified can be solicited or unsolicited by the users, who are recipients of these messages. An important (though not the only) application is for the detection of unwanted, unsolicited email messages, commonly known as spam. Internet Service Providers (ISPs) can also use this method to attack spam, without necessarily involving their customers.

The technique described below can be used to stop spam at propagation time before it reaches the end users, or after it has been received by them, but before they actually view the messages.

1. Canonical Reduction

Consider a message received at a provider or by a user. Typically, it has a header and a body. If it is email, the sender can forge most of the data in the header, relating to the relays, if any, and the From line, which purportedly gives the sender's email address. Here, the relays are intermediate nodes on the network that have presumably forwarded the message. Of course, any sender, even one who does not forge the previous items, can write a subject line. And, for any ECM space, the sender writes the body.

Bulk messages have the characteristic that the sender starts with a given message, and sends out many copies of that message. These may number in the millions, for spam. Who sends bulk messages? We can divide this into mostly two groups, newsletter writers and spammers. In either case, the copies of a message are identical or nearly so. Some antispam techniques used by others try to test for an exact match between an incoming message and messages that have been deemed to be spam, where the latter determination may have been attempted by various means. This test may be done by literally comparing the body of a message with the bodies of known spam messages. But a literal string comparison can be very slow, given that the sizes of message bodies can vary widely. So another test might be to take the spam message bodies and replace these with some type of digital signature, like a checksum or a hash. Then, an incoming message will have its signature computed and then compared to the table of spam signatures.

The problem with either approach is that spammers have many ways to introduce variability into a message, especially if it is written in HTML, as most spam is. The main reason that most spam is HTML is because HTML permits the display of images and hyperlinks, and many users read their mail in programs that can display HTML, like browsers. The hyperlinks are important, because these are usually to a spammer's domains, and the ease of clicking on them caters to an impulse buy action that the spammer desires in the user.

We define here a “canonical” form of a message as a transformation of the message's body that reduces as much as possible the variations that can be introduced into it by a spammer. We call the steps in the transformation “canonical steps”. We describe in detail a preferred implementation.

For brevity, below, we will assume that the message is seen in a browser, when explaining the reasoning for our method. But the actual canonical steps are independent of how the message is viewed. Also, we will say at times, for brevity, that a message is “read” or “seen” by a user. The viewing mechanism might instead be a purely audio display, e.g. for blind users. Also, we will say at times, for brevity, that we apply various steps to a message. In general these all operate on a copy of the message. The original message is not altered by these steps. Though eventually, as a consequence of these steps, a message may be classified as unwanted bulk (spam) and discarded by the recipient or the recipient's message provider.

Most steps apply one of two ideas. Firstly, a message actually has two audiences. There is the eventual, and desired, human audience. But there is also the machine audience, namely the browser or other program that gets the message and shows it to the human. A general technique that spammers have to introduce variability is to put it into the parts of the message that are received by the browser, but which it does not make visible to the user. Thus several steps involve removing data that is unseen by the user.

Secondly, of the visible portions, if there are alternate descriptions that produce the same visible text, then we choose one such way as “canonical” (standard).

These two ideas motivate most of the steps described below in the preferred implementation. It should be understood that the ideas can also be applied to other types of electronic messages that may possibly use other formatting languages or approaches to define them.

Many of these steps are optional. This ability to vary which steps are performed has utility in and of itself. It gives a process whereby a user, or a group of users, as represented by a peer group or by a message provider, can empirically determine which choice of steps yields best results in detecting bulk mail. It is possible that in different parts of the world, or over time in a given region, bulk messages, and particularly spam, may have characteristics that change. So some steps might become superfluous and new steps might be added.

The order in which the steps below are optionally done may possibly be varied.

Along with many of the steps, we construct what we term “styles”, which we associate with the message. These describe the presence of various language independent characteristics or heuristics in the message. Section 6 describes these more fully.

We start by noting that if the message is base 64 encoded, or encoded via the quoted-printable method, we decode it appropriately. And we set a style bit that says the message was encoded using one of these encodings. These encodings are sometimes used by spammers to avoid simple antispam techniques that do not do this step. Most browsers can automatically detect these encodings and decode them. If, in the future, another encoding technique becomes widely known, and most browsers add the ability to decode it, then our method can also add a test for that encoding here, and do any appropriate decoding.

If the message has several attachments, then we treat each attachment as though it were the sole body of a message. Since an attachment can have subattachments, we descend this attachment tree until we get to attachments that do not contain subattachments. As needed, we might have to apply a base 64 or quoted-printable decoding to an attachment.

As an elaboration, it may be possible for a given message or attachment to be first encoded as quoted-printable and then this output is encoded as base 64. If so, then we would apply the decodings in the reverse order, to undo the encodings. More generally, if a series of encodings has been applied, then we apply the decodings in the reverse order.

Above, we remarked that some steps might be optional, and the order in which they are done might be varied. It can be seen that this first step is not optional. If an encoding has been applied, and we do not do the decoding, then all the other steps below are moot. It also means that this first step cannot be done later.

Optionally, we remove comments. In HTML, they are written like this, “<!--a comment-->”. Comments are the easiest way for a spammer to introduce variability. If comments are removed, it should be done here, immediately after decoding the message. Because it reduces the size of the message (assuming that comments are present) and hence reduces the computational effort required in subsequent steps. Plus, in the next step, it avoids finding links from comments, because these links have no meaning, and may in fact be used by spammers as distractors.

We extract domains from any links in the message. By links, we mean examples like “http://ball.stick.com/cgi-bin/ad” and “ftp://download.adomain.com/data.txt”. Links are an obvious and crucial element of spam, assuming that a spam message uses them, as most do, in fact. They are obvious because, if present, they are immediately visible to a casual manual perusal of the original message.

Links can be used in two ways. Firstly, to summon an image to the browser, e.g. “<img src=‘http://a.spammer.com/image/hi.gif’>”. We ignore these links. In part, because a spammer can access static images made available by unrelated third parties, who are not spammers. These images are image files that a third party uses for messages that it sends out, so that those access the images to build some HTML message. Typically, that third party does not want anyone else using them, but cannot or does not prevent this. It is important that we do not collect these links. Because a spammer could use these third parties to cause us to contaminate our data with non-spammers.

The second, and most important way to use links, is to go to another web page, e.g. “<a href=‘http://b.spammer.com/cgi-bin/buy?d=3’> Buy Now!</a>”. These are important, because they point to web pages controlled by the spammer, and a spammer gets paid when users clickthrough and, presumably, buy something on those pages. Thus, a spammer has every incentive to write a valid link.

So in this example, we have this URL, “http://b.spammer.com/cgi-bin/buy?d=3”. There are two directions that we go from here. Firstly, we extract the domain, which in this hypothetical case is spammer.com. This can be used to build an Exclude List, also known as a Real time Black List (RBL), against which to check the bodies of future messages. (We will discuss this in detail later.) It is the use of this domain that offers a significant “force multiplier” against a spammer. Some antispam techniques used by others store the URL, and, for example, try to compare such URLs from an incoming message against a table of those found from spam. This is of limited utility. It will work against a spammer who does not vary the URL across many copies of a message. But it fails against a spammer who can easily introduce variability into the the URL. For example, the spammer might use “http://b.spammer.com/cgi-bin/buy?d=3&id=123456789”. The extra “id=123456789” can then be varied uniquely across millions of copies of a message. The spammer's software that parses the URL can simply discard this extra argument. Even more, a spammer who has a web server sitting at b.spammer.com can parse and discard anything to the right of “http://b.spammer.com/”. Hence, there is no point keeping information to the right of the domain.

Now consider the ostensible domain b.spammer.com. It might seem that we should record this, instead of the URL. But actually, it is better to just keep spammer.com. The reason is that the latter must be bought by the spammer. But having done so, and established a web site, she can add names to the left of spammer.com with zero cost. In the simplest case, the spammer just makes b.spammer.com an alias that points to spammer.com. All she has to do is notify her upstream network provider. Within a few days, this alias will propagate to various nameservers and be accessible over the entire Internet. Within reason, she can make scores or more of aliases. More elaborately, if she has several adjacent Internet Protocol (IP) addresses, she can assign these to subdomains, and have multiple aliases for those.

Our method of resolving down to a domain does so to the actual name that can be bought. We also handle the cases where domains are in various country codes. Different countries have different policies as to what domains can be bought. For example, in an Australian domain, we would resolve down to spammer.com.au, which is 3 fields in the domain name. Whereas for a French domain, we would resolve down to spammer.fr, because France allows commercial domains to be directly before “fr”.

Optionally, we also replace any hexadecimals in the domain name. A domain might be written in an URL with an ascii letter replaced by its hexadecimal value. For example, a domain with ‘w’ in it might have instead “%77”, where 77 in base 16 is the ascii value of ‘w’. A browser can handle hexadecimal in an URL. So a spammer might use it, and thus we act against it by replacing the hexadecimal with its ascii equivalent.

Optionally, we also reduce the domains to lower case. URLs are not case sensitive in their domain portion. Again, this is a place for a spammer to introduce variability.

Hence, at this point in our canonical steps, we have found a set of domains from links in the body of the message, if these links exist. We set these aside for now.

Optionally, we reduce any upper case letters to lower case in the body. This is one source of variability. For example, a spammer might choose to randomly write various words in upper case across different copies of a message. In passing, we should add that our methods are language independent. Currently, we just do this step for upper case ascii letters. But a simple extension is to do so for all letters written using Unicode, for languages with a different alphabet and which have upper and lower cases.

Clearly, when we make the choice of replacing upper case with lower case, we could have equally well replaced lower case with upper case. There is no logical advantage of one over the other. The point is to make a definite choice.

Not all languages that use alphabets distinguish between upper and lower cases, like Hindi, for example. So for those, forcing letters to lower case apparently is moot. It is also apparently moot for languages that do not use alphabets, like Chinese and Japanese. But even if we somehow know that all the messages we get are in Chinese, say, this step should still be run, at a minimum against any ascii characters. The reason is the widespread worldwide use of English in business and technology. So Chinese messages might have the occasional English text. And Japanese has a written form called romanji which explicitly uses the Latin alphabet.

It is possible that text to be shown in a browser can have numerical entities. A numerical entity is something like “&#97;” which represents ‘a’. The 97 is in base 10, and is the ascii value of ‘a’.

It can also be written in hex, like “&#x61;” for ‘a’, where 61 in base 16 is 97. As an extra fillip, there can be some number of leading zeros, like “&#00097;” or “&#x0061;”. Most browsers will discard any leading zeros. Then, if a numerical entity represents a displayable character, like ‘a’ in this example, the browser will display it. Numerical entities are meant to be used when there are nondisplayable characters present. But in implementations that can handle these, it was also permitted that displayable characters could be represented in this way.

One unintended consequence was that it lets a spammer introduce massive variability into the visible text. Consider again ‘a’. It has two representations, in decimal and hex. For each, we could prepend up to three leading zeros. This gives a total of 2×4=8 ways. Plus the original ‘a’ gives 9. In other words, in every place where ‘a’ appears in visible text, a spammer has 9 ways to vary it. And this is true of other letters as well. So for example, she can choose 7 letters and vary them in this way to make 9**7 (approximately 5 million) unique copies of a message.

Therefore, if we find a numerical entity, we choose one of three options:

1. We do not change it.

2. We remove it.

3. (Preferred option.) We replace it, in the following manner. If it represents a printable character, we replace the entity with that character. (If the character is upper case, we push it to lower case.) If the entity is not a printable character, then we replace it by a standard form, in which we remove any leading zeros. Then we write it in decimal, not hex. This choice of standard form can of course be replaced by any equivalent representation.

It should be understood in item 3 above that several logically equivalent implementations are possible, for an entity which is not a printable character. For example, instead of removing any leading zeros, we could explicitly impose one leading zero. Independently of this, we could write it in hex instead of decimal. All these choices for item 3 are equivalent. The main point is to make a definite choice.

Optionally, we remove any invisible entities. These are numerical entities which are essentially invisible to the eye, including, but not limited to, “&nbsp;” (no break space), “&emsp;” (em space), “&thinsp;” (thin space).

Optionally, we replace numerical entities between 160 and 255 inclusive. These have mnemonic names, like “&yen;” and “&auml;”. We replace all these by the one byte binary value that they correspond to. Then for any numerical entities between 128 and 159 inclusive, which are represented as, e.g. “&128;”, we replace with the one byte corresponding binary value.

Optionally, we remove any invisible and almost invisible text in HTML. Invisible text is where the foreground color is the same as the background color. A spammer can use this to write random text that will be displayed by the browser, but is not normally viewable by the user. We remove any such text.

Almost invisible text is where the foreground color is only slightly different from the background color. A spammer can use this instead of writing invisible text because the presence of the latter is often a strong indicator of spam. (What other reason is there for invisible text?) Here, any implementation of our method can choose a way to measure the distance between two colors, represented as Red/Green/Blue components, because that is how HTML uses colors, and to read some value as a maximum separation. So that any two colors separated by less than that value can be regarded as the same. This maximum separation can be read from a parameter file, for example. Hence almost invisible text detected by this can be deleted.

Another possible implementation is to have three distances, for each of the RGB components. If the differences between foreground and background components are all less than the corresponding distance, then we can define this as almost invisible text. The reason for the three components is that the eye has different sensitivities in these wavelengths. The eye is more sensitive in the blue or green than in the red. So a spammer might hide text by being able to vary the red component more widely than the other two.

Optionally, we remove any cascading style sheets.

Optionally, we remove any scripts, like javascript, for example. In a script, arbitrary logic could be encoded that does nothing, but which exists only to make different copies of a message unique. For example, imagine naming a variable “x1” in one copy, “x2” in another etc. A spammer could easily write code to generate javascript with unique variable names.

Now we come to a crucial step. Optionally, we remove all HTML tags. The reason is that HTML tags can be used to in several ways to generate numerous variations that are considered equivalent by a browser, including these:

1. Unknown HTML tags. For example, suppose this tag is written, outside any other HTML tags, of course, <heartwarm>. There is no such HTML tag as this. Thus a browser encountering it will ignore it, and not display it. This is a deliberate design decision for most browsers, for it enables a limited forward compatibility. So that future HTML tags should not break current browsers. But in doing so, it lets spammers create dummy tags.

2. Unknown HTML attributes. In an HTML tag, one can write unknown attributes, like, say, <body apple pear=55>. Like the previous example, a browser encountering unknown attributes will skip them and the display will be unaffected.

3. Variable attribute order in a tag. In the previous example, this is equivalent, <body pear=55 apple>. Whether or not the attributes are known or unknown or any combination. So suppose a tag has n attributes that are explicitly listed. From this, a spammer can make n! variations, spread across that many copies of a message.

4. Different quotes in attribute values. These are all equivalent—<body pear=“55”>, <body pear=‘55’> and <body pear=55>. Single or double quotes can be used. Or no quotes, if there is no whitespace inside a string. Another source of variability.

5. Varying attribute values. Consider, for example, a table tag with a background color, <table bgcolor=“#f3f1d9”>. Leaving aside anything to do with almost invisible text, this particular attribute can generate 2**24 different colors. Likewise any other place where a background or foreground color can be specified. Other examples include where the width of a tag element is specified, like <td width=“8”>. Or where a font size or font family is chosen. Et cetera.

6. Variable upper and lower cases in tag names. In the name of an HTML tag, all combinations are possible. Although here, we have removed this as a source of variability because we forced letters to lower case.

7. Varying whitespace in HTML tags. Inside a tag, we can put varying amounts of whitespace between the name of the tag and the first attribute (if there is a first attribute), and between the attributes, if more than one attribute exists.

8. Varying order of closing tags. Let <a> and <b> represent actual HTML tags, and suppose there are corresponding closing tags, </a> and </b>. If a encloses b, then they should be written like this: <a> <b> [ . . . ] </b> </a>. But HTML is permissively written, so that for many actual choices of a and b, most browsers will permit this: <a> <b> [ . . . ] </a> </b>. Another source of variability, where this is across tags. The previous examples were all inside a given tag.

9. Omission of closing tags. For certain tags, some browsers permit the omitting of a closing tag. This is usually if the tag is inside some larger structure, whose closing tag implicitly also closes its contained tags, without requiring the latter to be written.

Instead of removing all the HTML, one might considering retaining it, but pushing it into some standard canonical form. In principle, this is doable. Essentially, one has to “repair” the above sources of variability. But the programming is intricate, and the runtime computation is unnecessarily long.

Our method is simpler on both counts. The removal of HTML tags is easier to program (and debug), and it is quicker at runtime. While this removal is optional, we strongly recommend it. There is also another reason why we recommend the removal of HTML tags. It lets us find what we call templates. We explain this further below, in the discussion on protocol strings.

Optionally, we take the To line and split it in, as per this example. If the line says “To: Ahmed Malik <amalik@domain.com>”, we make the set {“Ahmed”, “Malik”, “amalik@domain.com”}. We push these to lower case. Then we remove any instances of each set item from the body, which just previously had any HTML removed. The removals here are to remove any personalization in the body, like “dear ahmed” (remember that text has been lowercased). We also remove any instances of the username, “amalik”.

Optionally, we remove some number of leading lines. To remove any personalization at the start of the message. The number of lines to remove here is a parameter which can be set at the onset of our method.

Optionally, we remove some number of trailing lines. To remove any personalization at the end of the message. The number of lines to remove here is a parameter which can be set at the onset of our method. Note that here, if we remove any lines, we might want to remove more lines than we might do at the start of the message. Some spammers write random text at the end of a message, in preference to writing it at the start. The idea is that a reader is less likely to notice it at the end, and even in this case, it means that she has presumably read the rest of the message.

Optionally, we remove any entire protocol strings, like “http://some.spammer.com/d3”. These protocols are those that were outside any HTML tags. Or which were present because there were no HTML tags to begin with. The list of protocols that can be used includes, but is not limited to these: {http, https, ftp, ftps, sftp, dns, gopher, IM, irc, ldap, ldaps, MMS, news, nntp, rlogin, rss, snews, SMS, smtp, prospero, ss7, ss7/ip, telnet, VoIP, wais}. Another implementation might wish to drop searching for any subset of these; perhaps because some protocols, like gopher, are not often encountered. Clearly, if new protocols become common, they can be added to this list.

We want to remove the protocols for a similar reason to why we extracted domains from links. Clearly, to the right of the domain name in a protocol string, a spammer can write arbitrary unique strings. So we need to remove these. But why do we then remove the remaining string, which has the domain name, like “http://some.spammer.com”? This decision is another important novelty we add. It helps find what we call templates. Suppose a spammer writes a message, with various protocol strings. These refer to a domain that she owns. She can also replace the full domain, like some.spammer.com, by its IP address. If we remove the domain, this can be detected. Now it might be objected that perhaps we could retain the protocols, and downstream, we could somehow have other steps to detect this, since we can go from a domain to its IP address. There are two problems with this. Firstly, it will be seen during the construction of hashes that two messages which differ only in this manner, one having a domain, the other having its IP address, will in general produce very different hashes.

The second objection is more important, because overcoming it gives us an important utility. Suppose the spammer also owns another domain, say, anotherdom.com, and this is not aliased to spammer.com, so it has its own IP address, which is also not in any IP address range associated with spammer.com. She can take her original message and replace all the protocol strings based on spammer.com with strings based on anotherdom.com. Of course, she also needs a web server running at the latter, to detect clickthroughs to it. It is not easy to detect this ownership of two domains programmatically. If we query the internet name registries for the owner of spammer.com, and then ask for what other domains the owner has, this is slow and brittle. She can easily obscure ownership of other domains via human proxies, who act as nominal owners. Or she can have several companies, each owning various domains, with the ownerships of the companies obscured.

Even worse is if she sells the original message to other spammers. They then write their domains into the protocol strings, and also into the appropriate clickthrough links in any HTML within the message. The technical ability of spammers varies widely. It is suspected that some spammers specialize in crafting messages that will defeat most antispam techniques. These spammers sell the messages to other, less technically inclined spammers, who then write in their domains in this fashion. Another possibility is that a spammer with no connection to the author gets a copy of the message as spam [!], and then proceeds to replace the links with her own. The author is rarely, if ever, able to enforce copyright.

A priori, there is no simple way to detect any of this. Our use of the term template to describe such messages should now be clear. It should also be apparent why we recommend the removal of all HTML tags and protocol strings. Retaining either type makes it much harder to detect templates, if it is even at all possible.

As an aside, in our explanation of why protocol strings should be removed, it might be considered that instead of removing an entire string, we retain the leftmost protocol stub, like http:// or http. There is no significant difference between retaining it and deleting the entire string. We arbitrarily choose the latter option as a preferred implementation.

Optionally, we remove any standalone email addresses. These are email addresses in the message with leading whitespace, and followed by either whitespace or a ‘.’ or are at the end of the message. The reasoning is the same as for finding templates. A spammer might write addresses in the body, which can be easily swapped out by another spammer using it as a template.

Optionally, we remove any domains, where these domains were those found earlier from the links.

Optionally, we remove whitespace, which is ‘ ’ [space], ‘\t’ [tab], ‘\n’ [newline] and ‘\r’ [carriage return]. This is one source of variability. A spammer could insert many instances of this. For example, consider the string “this is cheap!!” It could also be written with extra spaces between the words, leaving the meaning still clear to the reader. So that if we consider putting just 1 or 2 spaces between words, then doing this for a message of 21 words will give 2**20 variants, which is about one million.

Optionally, we remove punctuation. Symbols like ‘!’, ‘#’, ‘$’, ‘(’. Punctuation can be defined as any visible symbols which are not letters or digits in any alphabet, or which are not pictograms for words or phrases. This reduces variability. For example, consider the string “this is cheap!”. A spammer might also write “this is cheap!!” and “this is cheap!!!”. A simple way to introduce variations. In some ways, a spammer might consider introducing variations using punctuations to be better than inserting random letters or words. The reason is suppose you are a user who uses an alphabet-based language. If you see a random string like “aiasdedg”, you automatically try to interpret it as a word, and when you cannot, you see it as random, and potentially ugly and offputting to the entire message. To a lesser extent, this also happens if the spammer writes phrases chosen at random, like “truly rose baited looping”. If you can recognize words, then your mind automatically tries to parse these into a meaningful phrase. If it cannot, this can be offputting. But punctuation is different. Because even in principle these are not words, a group of punctuation symbols looks like a decoration or border, e.g. “===========****============”. Of course, now a spammer can make many variations. Which is why it should be removed.

It can be seen in the above preferred implementation that we considered mainly the case where a message was an email message, and HTML might be present. Our method has broader scope than this. Firstly HTML need not be present. This is already true in email. Secondly, many of the steps are still applicable even if the message is not email.

Thirdly, suppose that a message uses another markup language, in place of HTML. We can expect any such language to have some means of writing hypertext (which can include images) and which can be easily picked by the reader. This ability to link to another location on a network, and being able to go to it, is simply too useful to abandon. Then our idea of extracting domains from these links still applies. These might not be Internet domains, but locations on that network. If this new language lets an author introduce variability into it, akin to the HTML tags, then an optional step of removing markup information can also be used here.

2. Hashing

Having reduced the message to a canonical (i.e. invariant) form, we now break it up into parts and make n hashes of each, where n>=1. Though we recommend always using n>1.

There are several choices of hash algorithm to use, SHA1, MD5, . . . We choose SHA1, but this is not an essential feature of our method. The point about a hash algorithm is that it maps from a string into a fixed length output, such that it is highly unlikely that two different strings will give the same output. (“The Art of Computer Programming—Volume 3” by D Knuth, Addison-Wesley 1998, p. 513.) Alternatively, a message may be characterized by checksums (like Cyclic Redundancy Code) instead of hashes, which are often quicker to compute. The drawback is that there is greater chance of two different input data yielding the same number.

Let S be the canonical string for the message. If S is empty, or if its length is less than some predetermined amount, then we do not find any hashes, because the message is too short. This predetermined amount can be set arbitrarily. But we might have some policy that there is a minimum size of data to include per hash.

The simplest way to make n hashes from S is to break S into n equal parts, with the possible exception of the last part, which may have extra data, and then hash each part.

More elaborate methods are possible. For example, a message may have several attachments. Typically, one attachment is pure text, for use when the mail client cannot display HTML, while another attachment is HTML, for use when the mail client (usually a browser) can display HTML. In this case, one might choose to make n/2 hashes of the text attachment and n/2 hashes of the HTML attachment and ignore the other attachments. (Assume n is even, for simplicity.) Or one might choose to ignore the text attachment entirely, and make n hashes from the HTML attachment. The reasoning is that the spammer expects most readers to use a mail client that can show HTML, so we should also concentrate our efforts here. Whereas the text attachment is merely a backup for the fewer users who cannot see HTML messages.

We define two messages as canonically identical if all the hashes in each are present in the other. Notice that we are not saying anything about the order of the hashes being the same. Suppose for simplicity we make two hashes per message. Consider message N with hashes N1 and N2, and message P with hashes P1 and P2. Here, N1 was found from the first half of the canonical reduction on N, and N2 from the second half. Likewise with P1 and P2. Suppose that N1=P2 and N2=P1. So we say that N and P are canonically identical, even though their message contents are in opposite order.

One of the novelties we offer is that we make multiple hashes from a message, and not just one monolithic hash. The utility is that we have a much more powerful way to compare messages. If we just have one hash per message, then all we can say, in terms of hashes, is that two messages are canonically identical or not. But suppose we have n hashes per message, where n>1. We now have a quantitative way of seeing if two messages are “similar”.

We define two messages as canonically similar if each has at least m hashes that are present in the other, where 1<=m<n.

On the subject of how many hashes to make, the minimum number of hashes is of course 1. If we increase n, we can get finer grained comparisons between messages. But there is a greater computational and storage cost for the extra hashes. Plus, the greater n is, the greater the minimum canonical size of the message that we need in order to generate hashes. We have chosen n=6 as a reasonable workable value. Though our method is not restricted to this.

3. Micro-hashes

Optionally we can also make these. Later, we will explain how they can be used. Here, we explain how to make them.

Let T be a string that we are making a hash from. We also want to make a second hash from T, which we call a micro-hash or subhash. This hash is just as long as the first hash. The micro or sub refers to the fact that we will make it out of a proper subset of T, whereas the first hash is made from all of T. This is the key point here. The precise details as to how we find this subset are secondary.

Now we show a possible implementation of how to find a subhash. We have a parameter, called the subhash length. It is the length of a substring in T from which to make a subhash. Let x=subhash length. If length(T)>=x, then we hash the first x bytes in T and call this the subhash. Else, we hash the first length(T)/2 bytes in T and call this the subhash.

4. Applied in a p2p Environment

Having shown how we can derive a list of domains, hashes and styles from a message, we now show how this can be applied in a p2p environment. In a later section, we describe how to use our method on a message provider, like an ISP.

Suppose we are now a user, receiving messages, and that we can communicate with ones, in a p2p fashion, for the purposes of identifying unwanted bulk messages.

4.1 Local Comparisons

First we apply our method against incoming messages.

We can make a hash table of current communications, where “current” is over some time interval of our choosing. Plus, we find the domains and styles from these messages. In the making of this hash table, we have expanded the meaning of a message to what we call a Bulk Message Envelope (BME). It has the following items, where possibly some of these may not exist in any given BME:

1. Optional links to the full contents of one or more of the original messages from which the BME was derived.

2. Destinations (if these exist) found from links in the body.

3. Hashes.

4. Styles.

5. Relays.

6. The count=number of canonical copies of the message.

7. Header-derived data like the subject, co-recipients and sender.

The BME is an important idea. We illustrate by showing how the count is found. When we build our hash table, we put in the first message, and we make a BME for it. We set its count to 1. As each new message comes in, we make a provisional BME for it, with a count of 1. Then we compare the new message's hashes with those in the hash table. If there is already a BME with the same hashes as the new message, then we increment its count. We compare the domains in the new message to those in the existing BME. If they are different, then we have found an instance of templating. So we add the new domains to those in the existing BME, and we set a style in the latter that says “message copies have different domains”. Very suggestive of spam. (See section 6 for a fuller description of styles.) But if the BME made from the new message does not have the same hashes as an existing BME, then we add the new BME to set of existing BMEs. BMEs also let us find higher order aggregations of data.

Thus, in making a hash table of current communications, we can see amongst our own messages if there are any duplicates, where the count >1. We can also find any similar messages, where we choose how many hashes have to be the same for two messages to be similar.

We can also apply these tests against hash tables of historical data. This lets us find the most common redundant or undesirable communications from the last user-defined time period.

We can also annotate any of our messages. Typically, we would only do so for those that we consider spam. The annotation may grade the message according to its undesirability to us. We can also classify it, e.g. as financial, pornographic, health-related. We do this primarily to pool our results with others in our p2p network.

4.2 Remote Comparison Peer Groups

The reason for a user joining a peer group is to find out how many others have received any of her messages, and if so, which of these messages. There is a fundamental difference between our use of a p2p group and that of many other p2p groups. Those typically have users who know what they want (usually a song), but do not have it, and use their p2p groups to find and download a copy of it. In our system, a user already has items (messages), but lacks certain information about these (namely how many others have gotten copies), and then uses our p2p method to find this information. Essentially, our method is the inverse of those p2p groups.

There have been attempts by other antispam techniques to compare messages between users. One implementation might involve the forwarding of a user's messages to an offsite location run by a third party, which aggregates and compares the received messages from many users. The drawback is that few users will want to send all their mail to some other third party, for privacy reasons. Plus, few companies will want to do this with their mail, for corporate privacy reasons. It might be argued that perhaps the user could decide what mail was possible spam, and only forward those. But this is often manual. And if she could do this, she might as well delete the messages in question.

Our method is better because it does not send messages, but hashes from those messages. Preserves privacy. So a user can send hashes of all her messages in a blind query fashion described below.

In the steps below that describe joining a peer group, it is necessary for all the peers to use the same set of optional choices when reducing a message to its canonical form and hashing. In the interests of brevity, the descriptions assume that this is true when a user has made hashes and then joins a peer group. If not, a simple extra step might be added, where when the user joins a group, it tells her of their choice of settings. If these are different, she then recomputes hashing using this new choice, before sharing her data with them.

4.2.1 Joining a Peer Group

Peer groups are selected on several possible criteria, including but not limited to, the following:

1. Language of the communication (i.e., English, Spanish, etc).

2. Spam domain interest groups (scale-free network associations).

2.1. Users can be grouped using the common interest vectors derived from domains extracted from the bodies of messages received by the users. For example, if users get messages that many in the group independently regard as spam, then they can share the derived domains and classifications with the group.

2.2. Users can also be grouped using the results of finding many similar messages, as defined by having common hashes of messages' parts, and the inherent interests that are expressed in the messages.

2.3. The previous two methods can be used individually or in combination to define a group of users. The intent is that current and future spam to individual users is likely to go to many members of the group. Hence the likelihood of matching similar spam is greatly increased. Domains extracted from incoming messages can be checked against a list of domains to be excluded. The groups can change with time if the spammers' behavior changes, possibly due to shifts in consumer interest.

3. Geographic region of the user (usually country/continent).

4.2.2 Download Trusted Hash Tables and Other Data from Super Peer/Hub/Robot Peers

Having chosen a peer group, it may have a special member, which we call a super peer or hub, that aggregates results from the other peers. It may also have hash table and other aggregate data from super peers in other p2p groups. Super peers/hubs may also participate in a ‘super peer’ network with other super peers in a like fashion to the user-peer network to augment or create the data.

Robot peers are peer-clients that do not represent any actual person, but are just probe accounts that accumulate unsolicited communications; to be utilized in categorizing unsolicited communications in coordination with other peers.

We may decide to download data from a super peer and compare our messages against them.

4.2.3 Submit to Hubs/Peers/Super Peers/Robot Peers

Because we have made hashes from our messages, we can safely send these out to other users, and they can send theirs to us, while preserving the privacy of the messages. For messages which are not spam, and unique, the hashes thus generated are unique. For a hash of 160 bits, say, the chance that two independent data produce the same hash are 2**(−160). Given that for a message, we make several hashes, then this probability is lessened even more.

But if a spammer sends out thousands or millions of copies of a message, our method reduces immensely the variability that she can put into them. Because we hash after doing this, it increases the chances that several users will have canonically identical messages. This is why we want to share our data with others.

Submitting to a super peer/hub can be on several bases, including, but not limited to, the following:

1. Sequential and/or concurrent submission to a number of different peer groups to enhance matching probability.

2. Sequential and/or concurrent submission to a number of different peer groups on a time-delayed basis to capture leading edges of communication distributions.

3. Sequential and/or concurrent submission to a number of different peer groups to prohibit entities from compromising the matching process.

4.2.4 Matching Information

4.2.4.1 Anonymous Query Architecture

Although, in the description below, we focus on a specific utility of this process, we have developed a general anonymous query algorithm that determines the existence of a specific datum within a data collection (where the query able set has been hashed in the same manner) without exposing the data itself or any information about the ordering or structure of the data.

We do this by reducing the datum to be searched for, to a non-reversible hash value of sufficient uniqueness. The sufficient uniqueness requirement means that the non-reversible hash function utilized must guarantee that the odds of any two datum that are not identical mapping the same non-reversible hash value should be vanishingly small. (In the present implementation we have used SHA-1.) We can then query on the existence of this value from a list, or database of any sort, that has been similarly hashed, without giving any information about the item being matched; except to other holders of the same hashes and who also have the original data from which the hashes were derived, and who also know the relationship between the data and the corresponding hashes.

When notified of a match, we can request verification by asking for a subhash calculated from the original datum; optionally using a processing rule to be used in the calculation. A simple rule could be, specifying a random offset into the sample datum, to be used as a starting location for calculating the hash. If we further allow the sample to be treated as a ring buffer, then we do not leak any information regarding the sample sizes used for the hashing.

We can gain further certainty by requesting each matching notification to generate a different sub-hash of the original datum; say by incrementing the starting offset for sub-hash generation, and never using the same offset twice.

As a further security measure we could accept only one match notification from any given source.

As a further security measure we could generate some number of fake hash values (Distractors or Hash Distractors) that we would mix with our legitimate hash values to obscure what we were looking for. In general, we might want to have large numbers of Hash Distractors for each real hash value, so as to maximize the privacy of our search.

Once we are satisfied that a match is valid, we might request/accept from the remote data collection any value, properties, or collections thereof, that were associated with the matched datum. As a further security measure, we could require some minimum number of matches, associated values, and/or matching-associated values, before fully trusting a match notification and/or the associated values.

Different uses/users of this algorithm may implement different ways of exchanging data.

4.2.4.2 P2P Use of Anonymous Query Architecture

One possible way might be for a user joining a group to send hashes of her messages to a super peer or hub. This hub knows the addresses of the other members. It sends copies of her data to them, and downloads to her the copies of the other users' data that was earlier sent to it. If a peer gets data from a hub, that originated in another peer, the data will indicate the id of that peer.

Another way would be for a hub just to maintain a list of its members. Then a new user is added to this list and she downloads it. She then sends her data to the members on the list. In turn, they send her their data.

By whatever method, a user/peer, Lucy, gets data from some other peer, Santosh. Lucy matches Santosh's data against Lucy's current and historical communication hash tables. For any of Lucy's messages that exactly match all the hashes in one of Santosh's messages, Lucy tells Santosh. Santosh then needs to send the full hashes, and one subhash for each hash, plus any optional categorical information and comments that Santosh might have written about the message.

The subhashes are used for verification, and to prevent a spammer, or some other person, spoofing. Suppose before Lucy got data from Santosh, she sent her hashes out to Santosh. (One of them usually has to go first.) Then Santosh merely sends this data back to Lucy, claiming those came from his messages. To prevent this, Lucy requires Santosh's subhashes. She then compares those against her subhashes. Only if these all match hers will she be satisfied that Santosh had also gotten a canonical copy of her message.

There is another possibility of spoofing here. Suppose Santosh was not spoofing, and the subhashes that he sends to Lucy agree with hers. But also suppose that someone else in the peer group, Andre, was able to listen to the conversation, and that he had earlier received Lucy's hashes, but waits before replying. Now Andre replies, saying that he has seen her hashes, as derived from his messages. Lucy asks him, as she did Santosh, to send subhashes. Andre sends the subhashes that he recorded from Santosh's earlier reply. So Lucy gets fooled.

A countermeasure is possible. When Lucy asks someone for subhashes, she randomly picks an integer which is an offset into the string from which a subhash will be found. Then the subhash is found from this position in the string onwards. So when Lucy asked Santosh for subhashes, she might choose, randomly, an offset of 5 bytes. But when she asks Andre, she might choose an offset of 3 bytes. So it is no use to Andre to know Santosh's subhashes.

If the chosen offset leaves the resultant substring, from which to make the subhash, too small to do so, then a simple fix is to treat the original string as a circular buffer.

More elaborate protocols could optionally be devised. But the above use of subhashes should suffice in most cases. The key idea about subhashing is that for another user to give us a correct subhash, she needs to have the same original (canonical) string as us.

Another useful and optional guard against spoofing is for a user to introduce distractor hashes. Interspersed with hashes made from actual received messages can be hashes generated randomly or pseudo-randomly. The proportion of distractor hashes to non-distractors can be arbitrarily chosen by each user. Optionally, Lucy can inform the group that she has distractors in her hashes. Whether or not she does this, if Santosh later tells her that he has a message with one of her distractors, this is highly unlikely. Lucy does not need to ask Santosh for a subhash associated with that distractor, because in this case a subhash has no meaning. Lucy could choose to discard all the data Santosh sends her.

There is a second use of distractors. Here, these hashes are not made randomly, but are found by other means. For example, Lucy might have access to another peer group which hasamassed a list of spam hashes along with the original messages, as contributed by that group's users. This contribution might include a classification of the spam, as financial, health, etc. Lucy might add some of these hashes to hers, before transmitting to her current group. Why? While her private received messages cannot be inferred from the hashes made from these and sent to the group, hashes of spam can be used by others in the group who have received these messages to possibly infer what types of spam Lucy is getting. Most users in Lucy's situation will not care. But suppose Lucy does. Maybe she has found that most of her spam is gambling-related, and she does not want others to deduce this. She can use distractors from other types of spam, to dilute her hashes.

Distractors let a user obscure what she possesses or is looking for.

The p2p group can then aggregate hash tables and related data, like BMEs (but without the original messages inside the BMEs), from its members. From the BMEs with the highest count, the group can objectively count the largest bulk messages that it receives. Possibly using optional comments and classifications by the members, the group can make a collective decision as to which of these messages the group considers spam. (A group might possibly solicit the original full messages from its members, for messages that have been determined to be spam.) The group can offer the various spam BMEs to its current and new users, and possibly to other p2p groups or message providers. This might be done on a financial basis, or for some nonfinancial compensation.

Specifically, from the spam BMEs, the group can find the domains and styles. The domains can be consolidated into an RBL. An analogous list can be made from the styles.

5. Applied at a Message Provider

We now describe how our canonical steps and hash, domain and style extractions can be used if we are a message provider. By the latter, we mean, for example, an ISP. Or a company that provides email or Instant Messaging or similar services to its employees.

The Bulk Message Envelope (BME) defined earlier is also used here, and the descriptions of how it could be used also apply here.

We can apply the building of a hash table that was described in section 4.1 for the case of a user applying it to her own messages. But now, the scope is much broader. That method can now be used across all users' messages. This leads to an important addition to the contents of a BME:—

1. A list of users who have received copies of that BME, and the number of copies that each user got.

A useful simplification is that when making hashes, there is no need to make subhashes, unless the provider plans on exchanging hashes with another entity in the p2p fashion described earlier.

By algorithmically and objectively finding the most frequent BMEs, the provider typically has access to far more messages than any single user, or indeed, most p2p groups.

Just as section 4.2.4 could be used to make or augment an RBL from the BMEs with the highest counts, as found in a distributed (p2p) fashion, so too can BMEs be used here, but in a centralized fashion. Likewise with finding the Bad Styles from these BMEs.

Another utility of our method, when applied by a message provider is that the provider can act by itself, in finding bulk mail. There have been various antispam techniques built around the idea that senders of bulk mail should pay some fee, and that only such senders would get their mail forwarded to customers of ISPs. There are numerous problems with this approach. One of which is that agreement has to be reached by many ISPs and bulk mail senders. (Even then it is far from clear that this would work.) By contrast, our method is useful to one ISP, even if no other ISP in the world uses it.

Another advantage of our method is that it focuses on the bulk messages, and the largest copies therein. So if a spammer were to generate more copies of her messages, which is a brute force approach, these attract the attention of our method even more.

Another advantage relates to a technique that some spammers use to craft new spam. They set up accounts at major providers. Then, from other accounts, they email their accounts single or low frequency instances of messages. They use this to test the antispam techniques at the major providers. By tweaking their messages, they can empirically determine what works. All the time at low frequencies, to make it effectively impossible for the providers to detect this, given their message volumes. Then, when a message is found that passes the providers' filters, millions of copies are sent out.

In our system, single copies might be undetected. But a spammer cannot extrapolate from that to assume that a million copies will be undetected. If a single provider gets these many copies, our system will detect it.

Also, if our system gets widely deployed across major ISPs, there is another practical negative consequence for a spammer. Suppose she crafts a few experimental messages and they get through. That proves nothing. She would have to make many thousands, on the same scale as pushing out actual spam. It raises the cost of experimenting. Because if this is detected, and the site that she used to inject the messages into the network was found, that site could take measures against her, like closing her account. It raises her costs, with no revenue, if she does not put in her actual domains in the clickthroughs, for example. But if she does use her actual domains, and the messages are detected by our method, those domains can be blocked. Hence, she burns up domains and needs to find others. All these things add to her time, raise her costs and decrease her revenue.

Consider now the case where the message provider is a company that is not an ISP. It may be possible that it does not have enough users for our methods to detect sufficient bulk mail. It might then join a peer group, in the same way as discussed earlier for single users. Likewise, an ISP seeking to improve its hit rate might also do so. The point here is that the company or ISP can do so and still protect its users' privacy, because hashes are transmitted.

In a similar fashion, an ISP or company with a large database of hashes could make it available for searching by others, presumably for some type of compensation. This might not be considered as a p2p interaction, but the hashing is the crucial element that makes this possible while preserving privacy.

6. Styles

Here we describe how to apply various deterministic rules (heuristics) against a message. We call these rules “styles”. The rules try to detect whether a message has certain properties. Typically, most of these styles are used by spammers to evade various deployed antispam techniques. Hence, if a message has a given style, that can make it more likely that it is spam. Plus, if a message has several such styles, it might be even more likely to be spam.

We describe in detail many useful styles. The styles are divided into two groups. The first group are applied against single messages. We will later make methods involving the usage of these in conjunction with our other methods. The second group of styles are those that are based on our method of extracting a BME from its set of messages.

The present invention comprises that styles can be defined in any electronic communication modality.

The present invention comprises that styles can be applied to messages written in any human language.

The present invention comprises that styles can be found by a message provider, like an Internet Service Provider, or any organization, that sends and receives electronic messages to its users.

The present invention comprises that styles can be found by a group of users who send and receive electronic messages, both within the group and to and from outside users, where the group is defined in a peer-to-peer fashion.

The present invention comprises that styles can be found from incoming messages, and from outgoing messages, or both.

The present invention comprises that styles can be associated with any of: a message, a set of messages, a BME, a set of BMEs, a domain, a set of domains, a relay, a set of relays, a hash, a set of hashes, a user, a set of users, or any combination of these.

6.1 Message Styles

Many are listed here. Optionally, there could be more. These are applied against single messages.

1. Base 64 or Quoted-Printable Encoded.

Some messages have the body encoded in this way. A browser can detect this and automatically decodes it. The user is typically unaware that the message was ever encoded in this way. For brevity, we say this style is “base 64 encoded”; implicitly including the case when the message might be quoted-printable encoded. Some spammers use this to elude elementary antispam techniques that do not decode these encodings. One possible non-spam reason for using base 64 encoding is if the message contains some characters that some mailers might have trouble handling. Base 64 output is strictly ascii, so any mailer can cope with this. But because of this reason, the presence of a base 64 encoded message is suggestive of spam, and not conclusive.

2. From Line Missing.

Some spammers decide that instead of forging a From line, to just leave it blank. Most regular non-spam messages are written and sent using message software that automatically inserts a From value for the sender. Its absence suggests that something active was done to make it so. In practice, most spammers will not do this, but instead write a false entry.

3. HTML Message has ‘Small’ Images.

These images are sometimes called thumbnails. Some spammers use these to detect when someone has opened one of their messages. The HTML <img> tag loads a source file from the spammer's domain. But the load instruction can also contain information about the electronic address of the user. Hence the spammer can find out two important things, even if the user never clicks on anything in the message. First, the spammer confirms that the address is valid. Second, that it is active. Which raises the value of the address to the spammer for future use, including resale.

A image that is loaded in this way is typically only 1 pixel by 1 pixel. It might be the same color as the background. So often the user is unaware that such an image even exists.

The problem is that some major message providers also use thumbnails, for other reasons. So the presence of a thumbnail, in the absence of any other styles, is only suggestive of spam.

4. HTML Message has Only Images.

Some spammers construct messages in this way. Caution is required, because, for example, a user might sent messages just containing photos to her friends, where her friends might already be expecting these, and hence she puts no textual annotation with the images. So this style is suggestive of spam, but not conclusive.

5. Invisible Text.

This arises in HTML messages. A string is written with its foreground color equal to the background color. Hence when displayed, the user cannot see it. Though if she is using a browser, and she drags her mouse across the area where the text is drawn, it can be highlighted. In spam, it can be used to write unique random text in each copy of a message, that the user cannot see. This is used to defeat techniques that compare one message with another for matching.

The presence of invisible text is strongly suggestive of spam. There is little other reason for it to be present.

6. Almost Invisible Text.

This arises in HTML messages. A string is written in a foreground color that is very close to the background color. Subtler than writing invisible text, because the presence of the latter may well be taken as indicating spam. Here, the question is how to define ‘almost’.

One possibility is to define a maximum distance between the foreground color of a string and its background color, below which we consider it to be “almost invisible”. An antispam method should have some means of letting a message provider's system administrator set this. This leads to a binary result, 0 if no text is almost invisible, and 1 is some text is almost invisible.

An alternative method might be to define some metric d(foreground,background) for the distance between the two colors, scaled to [0,1]. Then use the result 1−d, which is now in the range [0,1], instead of being a binary result.

The presence of almost invisible text is possibly suggestive of spam.

7. Leading Zeros in Numerical Entities.

A numerical entity is something like ‘&#65;’ which stands for ‘A’. Most browsers will disregard several leading zeros, so that, for example, ‘&#00065;’ and ‘&#0065;’ and ‘&#065;’ and ‘&#65;’ will all be shown as ‘A’. So a spammer can create unique copies of a message, to foil simple exact comparisons of messages.

So unnecessary leading zeros are highly indicative of spam.

8. Misleading Visible URL.

For example, suppose we have <a href=“http://aspammer.com/di3”>http://good.com</a>. The visible part seen by the reader is http://good.com. But the link actually goes to aspammer.com. While the reader can see this, by either viewing the full text of the message, or by moving the mouse over the link and seeing at the bottom of the browser where the link goes, many might not notice. Phishing messages often do this. (See below.) Note that we do not consider the visible URL to be misleading when its domain is the same as the domain in the actual link, even if the two URLs are different. For example, consider this, <a href=“http://all.good.com/bin/test?ci=33”>http://good.com</a>. The base domain (good.com) is the same. There is valid reason here to make the two URLs different. The visible URL may be a simpler form of the actual link, to suppress unnecessary detail, that the reader can safely ignore.

9. Numerical Entities for Printable Characters.

Consider the earlier example of ‘&#65;’, which stands for ‘A’. There is no need to use the former in a message, when the latter is perfectly adequate. So a spammer can take text that is to be seen by the reader, and replace various letters by their numerical entity equivalents. This can be used to make unique copies of a message.

Very indicative of spam.

10. Numerical Entities in Decimal and Hex.

Consider the earlier example of ‘&#65;’ which stands for ‘A’. The 65 is in base 10. The entity could also have been written as ‘&#x41;’ which also means ‘A’. The 41 is in base 16. This is another way that a spammer can generate unique messages. So if a message were to contain numerical entities, for whatever reason, why should some be in decimal and others in hex? The presence of both in the same message is very indicative of spam.

11. Phishing?

Various tests have been tried to detect these messages. Typically, a message purports to be from a financial institution, according to the visible text in the message, usually accompanied by images that are downloaded from the institution's web site, if these images are accessible to anyone on the web. But the catch is that the user is asked to fill out a form, with sensitive information about the user, and then to submit this form. But the data actually goes to a third party site, where it is harvested by the scammer.

One way to attempt to detect phishing involves making a list of large companies and companies with a large presence on the web. Then given an HTML message, we can check for the following, if a <form> is present.

a. The domain in the form's action is present nowhere else in the message.

b. The domain is not in the above list of companies.

c. There are links elsewhere in the message to a company in the list.

d. The sender's domain is the same as that of the company in the previous item.

12. Random Comments in HTML.

Some spammers put HTML comments, whose contents are random characters. These can be detected through various known techniques. The biggest problem in doing so is the computational cost.

13. Raw Internet Protocol Addresses.

In links, some spammers might use these, instead of domain names, for deliberate obscurity. But non-spam that has links may sometimes also do this. Slightly indicative of spam.

14. Bad Relay Information.

Spammers can often modify most header information. They might alter the relay information to conceal the origin of the spam. Sometimes, they write invalid Internet Protocol addresses, or addresses of relays that are known to the receiving message server to be associated with spam.

15. Secure Protocols.

This refers to whether a link uses a secure protocol, https, sftp, ftps, ssh. It is different from the other styles, where the presence of one of those is at least suggestive of a negative datum about a message. The presence of a secure protocol is not necessarily a bad thing. In some cases, it might be desirable.

16. Subject Line Starts with ‘ADV:’.

This may be taken to be spam. Some of the more respectable spammers write this in the subject line, in part to conform with a California regulation. But most spammers do not bother. Still, a few percent of bulk messages often has this, and it is simple to check, so it is worth doing.

17. URLs Have Hexes Instead of Chars.

In a URL, a character can be represented by its hexadecimal equivalent. For example, ‘w’ can be written as ‘%77’, where 77 is hex for the ascii representation of ‘w’. Spammers can use this to either generate unique messages, or to obscure where a link is pointing to. Because seeing ‘%77’ in an URL is far less meaningful to most readers than ‘w’, for example.

18. Unknown HTML Attributes.

In an HTML tag, a spammer can write an attribute that does not actually exist for that tag. A browser seeing this will ignore it, for forward compatibility. Hence it does not affect what the user sees. But the spammer can use this to introduce uniqueness into messages. Very indicative of spam.

19. Unknown HTML Tags.

In an HTML message, a spammer can write a tag that is not actual HTML. Most browsers will ignore this, for forward compatibility. Hence it does not affect what the user sees. But the spammer can use this to introduce uniqueness into messages. Very indicative of spam.

20. Variable Attribute Order in HTML.

In a given HTML tag, if it has two or more attributes, these can be written in any order. The display is unaffected in most browsers. So if there are n attributes, a spammer can generate n! variants of the tag by this means. In a given message, suppose a particular type of tag appears several times. If it has the same attributes in two or more instances, and the order of these varies, then this style is present.

Possibly indicative of spam.

21. Variable Quotes in HTML Tags.

In an HTML tag, we can set the value of an attribute by either, e.g., a=‘14’ or a=“14”, or by not using quotes at all, if there is no whitespace in the value. But where quotes are used, these can be single or double. If a message has some cases of using single quotes and others of using double quotes, then this style is present.

22. Variable Upper and Lower Cases in HTML Tags.

In the name of an HTML tag, any combination of upper and lower cases is possible. For example, these are all the same to a browser: <body>, <BODY>, <bODy>. Another way for a spammer to introduce uniqueness. If a message has variable cases, then this style is present.

23. Varying Whitespace in HTML Tags.

Inside an HTML tag, we can have any amount of whitespace between attributes and between the name and the first attribute, if there are any attributes. The browser displays the same thing, regardless of the amount of whitespace. So we can measure the amount of whitespace and see if it varies.

6.2 BME Styles

Most of these styles rely on the use of a Bulk Message Envelope (BME). This is an important difference between these and the Message Styles, which are all applied against single messages. In the making of a BME, we have invented the styles described in this section.

Below, where we discuss fractions of various items, this is just for convenience in normalizing the output to be in the range [0,1]. There is no significant difference between this and, say, counting the various items.

The present invention comprises each of these styles.

1. Canonical Body Empty.

After performing the canonical steps on a message, sometimes this happens. Suggestive of spam, because the steps removed possible places where a spammer could introduce spurious variability. Typically, non-spam messages have enough “real” material that something remains after the canonical steps.

2. Message Copies Have More than 1 from Line.

It is well known that spammers often forge the subject line of their messages. Despite this, some antispam techniques still block against the sender line of messages deemed, by whatever means, to be spam. However, we have found a way to use the sender line, and the very fact that it can be forged, as a strong indicator of spam. This style refers to the use of the canonical steps and hashing on a set of messages. Then, the message hashes are compared across messages. If two messages are canonically identical, that is, they have the same hashes, then they are part of the same BME, and we look at the From lines. If these are different, it is highly suggestive of spam.

It is difficult for spammers to counteract this. If a spammer uses only one false sender address per set of copies of a message, then other existing antispam techniques may detect and block against that particular address, false though it may be. Which is why spammers often generate a set of false addresses. But if we detect this style, it is virtually conclusive of spam.

3. Message Copies Have More than One Subject Line.

In a similar way to the previous style, it is well known that spammers often generate different subject lines, for a set of copies of a given message. Other antispam techniques often devote what is futile attention towards parsing the subject line of messages.

This style refers to the use of the canonical steps and hashing on a set of messages. Then, the message hashes are compared across messages. If two messages are canonically identical, that is, they have the same hashes, then they are part of the same BME, and we look at the Subject lines. If these are different, it is highly suggestive of spam. After all, why should two identical messages have the same subject line? Note that all we need check for is that the Subject lines are different. We do not care what language these are written in. This is one advantage.

Another advantage is that we do not need to keep a list of words that might indicate spam, like “free” or “Easy Credit”, to try to find in a Subject line. Quite apart from the fact that these are in one language, English, it is well known that spammers who want to put these in the Subject line can vary the spellings heavily.

Another advantage is that we do not need to somehow infer if the “meaning” of a line is different from that of the actual body. This is vastly easier than some antispam techniques that attempt to see if a Subject line is “misleading”.

4. Message Copies Have Different Link Domains.

Our method of canonical reduction and hashing helps us find templates of spam. In making a BME out of a message, if we find another message whose hashes are the same, then we compare the link domains that we have extracted from both messages. If there are different link domains, it is highly suggestive of spam, and specifically of template spam. That is, the original message may have been constructed with blank link entries, as a template. Then it may have been sold to other spammers, each of whom inserted her own domains into her copy. (And then presumably made many thousands of instances of it.)

5. Too Many Relays in a BME.

When we made a BME from a message, and then found another message with the same hashes, we also compare the relay paths. Each message can have a list of relays, that indicates the path it took. But these entries could be forged by a spammer to hide her origin, in the same way that she might forge the sender line. Here, if we find that a relay path is different from any of those already in the BME, we add it to the BME. Plus, we check against a setting which is a maximum number of relay paths per BME. If the total number of paths is greater than this number, we set this style. That maximum number can be changed by each message server's administrator. The reasoning behind recording this style is analogous to that for the previous styles. Here, suppose we have multiple copies of a message being sent out. If they came from the same location, then their paths should often be the same. It is possible that occasionally the paths might be different. That is inherent in the Internet Protocol, because a relay might go down for some time, during which a copy of a message might then travel via a different path than an earlier copy.

Notice that here, this style does not care if the relay information is true or false. Suppose all the relay information is true. That means that we have seen canonically identical messages arrive from different parts of the net. What are the chances of truly independently written identical messages doing so? Very indicative of spam, where we have several spammers at different locations. Now suppose all the relay information is false. Why should canonically identical messages arrive via many different paths? It suggests that the information is false, which we infer as in turn suggesting that the messages are spam. We are assuming that senders of non-spam will not forge headers.

Look carefully at the styles 2-5 in the previous list. Bulk messages contain mostly spam. But a significant subset of bulk is newsletters. These may be noncommercial or commercial. One significant problem that many antispam techniques have is distinguishing between newsletters and spam. It is not sufficient to say that by manual inspection, one could tell the difference. This may well be true. But given the volume of messages, it is desirable to find a programmatic means of doing so. We offer a method.

We suggest that most real newsletters do not forge their headers. So they do not forge their From lines and the relay information. Plus, when they send out copies of a message, the subject line is the same. Therefore, we have the following.

The present invention comprises the use of styles 2-5 in the previous list in distinguishing between newsletters and non-newsletters (mostly spam) in bulk messages.

The present invention comprises of these other styles, as applied to a BME or an arbitrary set of BMEs.

1. Fraction of a BME's domains, or a set of BMEs' domains, that are in a Real time Black List (RBL). Here, the RBL could be obtained from an external data source. Or it might be derived from current or historical data available to us.

2. Fraction of a BME's relays, or a set of BMEs' relays that are in an RBL. See the comments from the previous item. Here, the RBL could be for domains in general. Or it might be an RBL of specifically suspect bad relays.

3. Fraction of a BME's domains, or a set of BMEs' domains, that are in a table of suspected link farms. A spammer may search for extra revenue by running a link farm. This table may be generated by us or by some external entity that we regard as reliable in this respect.

4. Fraction of a BME's domains, or a set of BMEs' domains, that have no home pages. If a domain is, say, aspam.com, then we look for a home page at either aspam.com or www.aspam.com. Even most spammers will probably have home pages. But a lack of a home page may be considered significant. It may indicate fraudulent spam.

5. Fraction of a BME's users, or a set of BMEs' users, that have complained about it. Here, by users, we mean the recipients of the BME.

6. Fraction of a BME's hashes, or a set of BMEs' hashes, that are in a table of known bulk message hashes. The table might be considered as an RBL of hashes. The table could be obtained from an external data source, or derived from current or historical data available to us.

7. Fraction of a BME's users, or a set of BMEs' users, that are probe accounts, where these accounts actually exist. This can be used to see how a spammer is harvesting addresses.

8. Fraction of a BME's users, or a set of BMEs' users, that are nonexistent accounts, and which have never existed. This can be used to see if a spammer is using a dictionary attack to guess addresses. For example, suppose we are running adomain.com and that there has never been a username of ‘dave’, which is general is a common username. If we see spam arriving for dave@adomain.com, and where we have never posted that address on the web, then it suggests a dictionary attack.

9. Fraction of a BME's users, or a set of BMEs' users, whose addresses can be found on search engines. The idea is to get some indication of how a spammer might be finding addresses. We do not suggest that the spammer is using a search engine. Rather, if a search engine finds web pages with some users' addresses, it suggests that these pages may be targeted by a spammer's spider.

10. Fraction of a BME's domains, or a set of BMEs' domains, with nearest neighbors in Internet Protocol space that are in an RBL.

11. Fraction of a BME's domains, or a set of BMEs' domains, with nearest neighbors in Internet Protocol space that are in a table of suspected link farms.

6.2.1 Domain Styles

For the case of a domain, the present invention comprises these styles.

1. Is the domain in an RBL?

2. Is the domain in a table of suspected link farms?

3. No home page for the domain?

4. Number of its users that have complained about it. By a domain's users, we mean the recipients of BMEs, where the BMEs have this domain.

5. Number of its hashes that are in a table of known bulk message hashes. By a domain's hashes, we mean the hashes in BMEs with this domain.

6. Fraction of a domain's users that are probe accounts, where these accounts actually exist.

7. Fraction of a domain's users that are nonexistent accounts, and which have never existed.

8. Fraction of a domain's users whose addresses can be found on search engines.

9. Number of the domain's nearest neighbors in Internet Protocol space that are in an RBL.

10. Number of the domain's nearest neighbors in Internet Protocol space that are in a table of suspected link farms.

6.2.2 Sender Styles

Suppose now we look at outgoing messages, sent by our users. Here, we call them senders. We assume that the senders are unable to forge the header information. We can also apply our canonical steps to make BMEs, just as we do for incoming messages.

The present invention comprises these styles.

1. Fraction of a sender's domains in her messages that are in an RBL.

2. Fraction of a sender's domains in her messages that are in a table of suspected link farms.

3. Fraction of a sender's domains in her messages that have no home pages.

4. Fraction of a sender's recipients that complain about the sender.

5. Fraction of a sender's hashes in her messages that are in a table of known bulk message hashes.

6. Find average Message Styles for a sender from her messages.

7. Fraction of a sender's domains in her messages with nearest neighbors in Internet Protocol space that are in an RBL.

8. Fraction of a sender's domains in her messages with nearest neighbors in Internet Protocol space that are in a table of suspected link farms.

In passing, we explain explicitly this detail about item 1 above. Suppose an RBL has a domain, aspammer.com. If Latifa writes a message containing this string, “Hey, I heard that aspammer.com is cool!”, our method does not extract “aspammer.com” from her message and then possibly mark the message as “bad” because the domain is in the RBL. Typically, the recipient of her message will not be able to click on that domain, in most types of viewing software, like a browser. But, if Latifa were instead to write “Hey, I heard that http://aspammer.com is cool!” or “Hey, I heard that <a href=‘http://aspammer.com’>aspammer.com</a> is cool!’, then our method would extract “aspammer.com”, because most viewing software will write those two examples as clickable links. This is a deliberate feature of our method. As another way to attack spam, it discourages non-spammers from writing clickable links to spammer domains.

Item 4 also deserves some comment. It is different from the common ability of a recipient of an unwanted message from, say, anita@adomain.com, to reply to, e.g., root@adomain.com, complaining about anita and enclosing the unwanted message. In this example, we are running adomain.com and we get this message. If anita sends out messages that are different from each other, but actually canonically identical, then just as we can build a BME, here we can aggregate complaints that are actually about some canonically identical message.

The above styles can be computed over some time period. Which leads to us to have these styles, for comparing a sender's current behavior to her past behavior.

1. Find a sender's domains that are in an RBL, over some long time period and over a recent time period, and compare these for deviations.

2. Find a sender's domains that are in a table of suspected link farms, over some long time period and over a recent time period, and compare these for deviations.

3. Find a sender's domains that have no home pages, over some long time period and over a recent time period, and compare these for deviations.

4. Find a sender's recipients that complain about the sender, over some long time period and over a recent time period, and compare these for deviations.

5. Find a sender's hashes that are in a table of known bulk message hashes, over some long time period and over a recent time period, and compare these for deviations.

6. Find average Message Styles for a sender from her messages, over some long time period and over a recent time period, and compare these for deviations.

7. Find a sender's domains with nearest neighbors in Internet Protocol space that are in an RBL, over some long time period and over a recent time period, and compare these for deviations.

8. Find a sender's domains with nearest neighbors in Internet Protocol space that are in a table of suspected link farms, over some long time period and over a recent time period, and compare these for deviations.

The present invention comprises these styles, for comparing a sender to other senders.

1. For all senders, find a sender's domains that are in an RBL, over some time period, and compare these for deviations.

2. For all senders, find a sender's domains that are in a table of suspected link farms, over some time period, and compare these for deviations.

3. For all senders, find a sender's domains that have no home pages, over some time period, and compare these for deviations.

4. For all senders, find a sender's recipients that complain about the sender, over some time period, and compare these for deviations.

5. For all senders, find a sender's hashes that are in a table of known bulk message hashes, over some time period, and compare these for deviations.

6. For all senders, find average Message Styles for a sender from her messages, over some time period, and compare these for deviations.

7. For all senders, find a sender's domains with nearest neighbors in Internet Protocol space that are in an RBL, over some time period, and compare these for deviations.

8. For all senders, find a sender's domains with nearest neighbors in Internet Protocol space that are in a table of suspected link farms, over some time period, and compare these for deviations.

The utility of the sender-specific styles is that we can programatically watch to see if a sender's behavior, as measured by the outgoing messages, changes compared to her past history, or if it is quite different from that of other users. It can be used to detect if, for example, someone has found a user's password and is then using her account to issue spam. Or, for a new user, who has no past history, it can be used to detect if she turns out to be a spammer. This goes far beyond doing a simplistic count of how many messages a sender produces.

6.2.3 Time-Based Styles

A BME can also store the times in the relay header information. But in general, only the arrival times when messages are received by us can be considered reliable. Relay times can be forged by spammers.

The present invention comprises the finding of the fraction of a BME's messages, or of a set of BMEs' messages, with relay times that are before the arrival times minus some maximum transit time.

This maximum transit time is chosen by us. It can be a function of the communications protocol. For example, with the Internet Protocol, we might chose a time of 4 days, reckoning that it is unlikely that any message would take so long to reach us.

There might also be messages offering goods or services in a given time interval. (“48 Hour Thanksgiving Sale. Hurry!!”) Thus the following method. In this, we mention sending times, as well as arrival times. The former can cover the case where we are a message provider with users sending out messages and we make BMEs from outgoing messages.

The present invention comprises the finding of the fraction of a BME's messages, or of a set of BMEs' messages, with sending or arrival times that are in some given time interval.

6.2.4 Geographic Styles

Here we describe various styles using BMEs in a geographic context. Below, when we mention a user or users in a method, it is assumed that the user or users have associated BMEs.

The present invention comprises the method of deriving the number and list of countries or locations from the domains in a BME, a set of BMEs, a user, or a set of users. In the latter two cases, this can be for incoming or outgoing messages or both.

The method is this. Given a BME or any of the other cases in the previous method, we can extract a list of domains that are pointed to. (If there are no domains in the original messages, then of course this list is empty, and the method ends here.) We use publicly available registration information for those domains to find the network providers hosting them. Then, other public information gives us the geographic location of those network providers, and hence the countries they are in.

Why might this be useful? A spammer might want to locate her domains outside the country that she is sending messages to. Hence, here it is the countries that is significant, rather than the actual distances between those network providers.

But in other circumstances, actual geographic locations might be useful. So in the above method we allow for this, where there might be some distance threshold chosen, so that two locations within this distance only count as one location.

In the above cases, when we described finding geographic data from a user or set of users, the method was to look at the associated BMEs, and thence from the domains in those, extract the geographic data. But there is another way to extract geographic data from a user or set of users. It is via the geographic locations of the users' message providers. If the canonical steps are done by an ISP or company, say, for its users, then there is only one location, and the utility is limited. But suppose that we have a p2p group of users, where the users are scattered over different message providers. Then this information may be useful.

For example, suppose several users have addresses at ucla.edu, ucsd.edu, ucsf.edu and oxford.ac.uk. Of course, a user with, say, johndoe@ucla.edu can be anywhere in the world. But most UCLA users are, in fact, on or around the UCLA campus. Similarly, we can expect that most ucsf.edu users are in or near San Francisco. Then, if a BME is observed by the p2p group going mostly to users at ucla.edu and ucsd.edu, it might appear to be geographically targeted at southern California. Perhaps the BME is advertising something, like an event, that is located in that region? One might ask, if so, why don't we just read one of the messages in the BME. The point here is to find such information programmatically, without manual intervention. The latter should be possible, but only in exceptional cases, otherwise the sheer volume of spam will invalidate manual steps.

Of course, it is also possible in this example, that the spammer, for whatever reason, only managed to collect addresses in southern California, and that the spam has no intrinsic geographic constraint. But the example shows how we can programmatically find extra information that might be useful. Accordingly, we have the following.

The present invention comprises the method of deriving the number and list of countries or locations from a BME, or a set of BMEs, or a user, or a set of users; based on the locations of the users' message providers.

Earlier, we discussed the style “too many relays in a BME”. There is a similar idea where we look at the starting relays in the various relay paths in a BME. We can find the geographic locations of these starting relays, and thus the distances between them. If some of these exceed some threshold, the present invention comprises this as “relays are too far apart in a BME”. Because if copies of a message originate at one physical location, it is unlikely that they go to starting relays that are widely separated.

The present invention comprises the method of dividing a set of BMEs or a set of users, into two or more subsets for further analysis, via some geographic criteria that can be applied to the BMEs.

For example, suppose we have a set of BMEs. From these, we make a subset, call it “UK”, for all those BMEs with domains inside the UK. Or, we can make a subset, call it “FR” for all those BMEs with domains inside France. Clearly, it is possible for “UK” and “FR” to have common elements. If so, we can imagine drawing a graph with two nodes, UK and FR connected to each other. With the common edge, we can associate those BMEs with domains in both France and the UK.

There is another possible source of geographic information in a BME. It is technically possible to also store geographic information about where the user is, when she received a message, if such information exists. For example, consider a cellphone. Many made after 2001 have GPS capability. It is plausible that the cellphone could record in its memory where it is, to within the accuracy of the location method, for messages that it receives. Or perhaps that the cellphone provider does so. Various other communications methods, like WiFi and Bluetooth, also permit some location sensing.

The geographic data might also exist in other forms. For example, if we know the physical addresses of the users, because they gave this information when they joined our message provider.

For example, a shop might broadcast offers on a WiFi net to all passersby within the range of the net. Also, these offers might be made only during a certain time period, like, say, the week before Thanksgiving. So we can combine looking for both a region and a time, into the following.

The present invention comprises the method of finding the fraction of a BME's messages, or of a set of BMEs' messages, received when the user was in some chosen geographic region, and, optionally, when the messages were received in some chosen time interval.

Suppose that the sender information can be considered to be valid in most cases, in a given set of messages. Currently, for email, that is typically not the case. But in other ECMs, like cellphones and SMS, the sender phone number is generally considered reliable.

The present invention comprises the method of finding the fraction of a BME's messages, or of a set of BMEs' messages, received when the sender was in some chosen geographic region, and, optionally, when the messages were received in some chosen time interval.

Combining the previous two methods gives us this dependent method.

The present invention comprises the method of finding the fraction of a BME's messages, or of a set of BMEs' messages, received when the sender was in some chosen geographic region and the user is in some chosen geographic region, and, optionally, when the messages were received in some chosen time interval.

6.2.5 Social and Scale Free Networks

Suppose from a set of BMEs, we remove most of the spam, perhaps by using styles that suggest a BME is spam, like having more than one subject or more than one sender. Then we are left with mostly individual, nonspam messages and newsletters. In either case, we can expect that the senders are now canonical, i.e. not forged. Given this, we can make social networks, using the To, CC and From lines in the case of email. (In other ECMs, we would use the analogs of these, if they exist.) The social networks have useful commercial applications. Being able to identify networks would have merit, for example, in allowing advertisers to offer targeted marketing.

Define users or domains A and B as “linked”, as derived from a set of BMEs, if at least of the following is true:

1. A BME has a message with A in its To line, and another message with B in its To line.

2. A BME mentions A and B in one of its messages' To line.

3. A BME mentions A and B in one of its messages' CC line.

4. A BME mentions A in one of its messages' To line and B in the CC line, or vice versa.

5. A BME has a message from A to B in its To line, or vice versa.

6. A BME has a message from A to B in its CC line, or vice versa.

7. A BME has a message with A, which here is a domain, in its body, and B in its To line, or vice versa.

8. A BME has a message with A, which here is a domain, in its body, and B in its CC line, or vice versa.

Notice that apart from the first item, all the other items mean that there was a message, as opposed to a BME, that associated A and B directly. The last two items also let us handle the case when a sender might be forged in some messages.

Define users or domains A and B as “indirectly linked” by a set of BMEs if they satisfy both conditions:

1. They are not linked.

2. A is linked to some other user or domain, which in turn in linked to another user or domain, et cetera, until a user or domain is linked to B.

The present invention comprises the method of finding the subset of a BME's messages, or of a set of BMEs' messages, with recipients or senders associated with a given set of users or domains (“Rho”), by one or more of the following steps, where a recipient could be a user or a domain, and likewise for a sender:

1. A recipient or sender is in Rho.

2. A recipient or sender is linked to a user or domain in Rho.

3. A recipient or sender is indirectly linked to a user or domain in Rho.

Notice that if we are a message provider, the above definitions and methods are not restricted to our local users. Here, a user or domain could be external, and sending or receiving messages to or from our users.

Look at the above definition of two items, A and B, being linked. The last 4 criteria differ from the previous ones, in that they let us draw a directed arc from A to B if there exists a message from A to B.

Define a user or domain A, as “upstream” from a user or domain B, as given by a set of BMEs, if A is linked to B and one or more of these conditions is true:

1. There is a message from A to B, or it has A in its body and B in its To or CC lines.

2. There is a path of nodes that are linked to each other, with one end at A and the other at B, and A is connected to its neighbor in the manner of the previous item, et cetera, all the way to B: A-> . . . ->B.

If A is upstream from B, we define B as being “downstream” from A.

Notice that if A is upstream from B by the second condition, that it does not necessarily mean that there was a sequence of messages, one after the after, that led to the building of the path A-> . . . ->B. But sometimes it may be useful to actually want find such a causal sequence.

Define a user or domain A as “strictly upstream” from a user or domain B, as given by a set of BMEs, if one of these conditions is true:

1. There is a message from A to B, or it has A in its body and B in its To or CC lines.

2. There is a message from A to another user or domain A1, and after this has been received by A1, there is a message from A1 to another user or domain . . . etc to B.

Notice that here we deliberately leave unspecified whether the times in the previous item are measured upon transmission or receipt of a message. This can be a policy choice, to use one or both.

Define an item A as “strictly downstream” from an item B, as given by a set of BMEs, if B is strictly upstream from A.

Obviously, A is strictly upstream from B=>A is upstream from B.

The present invention comprises the method of starting from a set, A, of BMEs, and a set, B, of items, like users or domains, and finding the items in A which are downstream or strictly downstream or upstream or strictly upstream from those in B.

Consider now the case when a user or domain is upstream, and is sending messages to another set of users or domains. If the sender is also a nexus (i.e. removing it splits the set into 2 disjoint groups) then it increases the chances that it is a bulk sender. Because it is sending to at least two disjoint groups. While we have methods to detect bulk message senders, it is useful to have another method. But in general, a bulk sender might receive occasional messages from its recipients, like asking to unsubscribe. Accordingly, we define the “flow ratio” for a user or domain to be the number of messages sent by it, or which have it in their bodies, if it is a domain, divided by the number of messages sent to it, if the latter is not zero. Otherwise, we define the flow ratio as infinite.

Therefore, below, we have two ways to detect bulk senders, where the second is the stronger.

The present invention comprises a method of finding possible bulk senders by starting with a set of BMEs, and finding the items, like users or domains, which are (upstream of other items, and are not downstream from any item) or which have flow ratios greater than some chosen value.

The present invention comprises a method of finding possible bulk senders by starting with a set of BMEs, and finding the items, like users or domains, which satisfy these conditions:

1. They are (upstream of other items, and are not downstream from any item) or which have flow ratios greater than some chosen value.

2. Are nexii.

3. [Optional] We take the disjoint sets of items defined by a nexus and find an interest classification of these sets, by whatever external means, and we find that the sets have little or no overlap in interests.

There is also an interesting application that can be useful to a message provider. Sometimes, a spammer might open an account at a provider, simply to receive test spam messages sent by the spammer from outside the provider. By experimenting with the composition of a message, she can adjust it until it gets past the provider's antispam filters. Thence, she can send bulk copies of the message to addresses at the provider. The spammer's account is a probe account, but different from those than might be used by the provider itself. In general, it is hard to detect a spammer probe account, because she will not use it to emit spam, and it receives new, leading edge spam in small numbers.

The present invention comprises a method to detect a possible spammer probe account by the following steps:

1. The account (user) is downstream from other accounts, or it has a flow ratio less than some chosen value. (That is, the account is used mostly to receive messages.)

2. Of the messages sent to the account, a fraction, larger than some chosen value, is indicated as possible spam by the provider's antispam methods. These messages might be rejected by the provider or sent to the account and indicated in some fashion as possible spam.

3. Of the messages received by the account, a fraction, greater than some chosen value, is later included in BMEs of bulk messages received by the provider.

The second item above includes the case where the provider might be using our method of applying an RBL against domains found in the body of a message. In this case, a spammer needs to send a test message with the actual domains used by her, in order to test if the provider has those domains in its RBL.

The third item lets the provider detect leading edge spam, albeit after the fact, when bulk copies of it have been received. Notice that this can be done even if the spammer deletes a successfully received message immediately upon receipt, so long as the provider applies our canonical steps to all incoming messages.

Suppose that the provider has found a suspected probe account, after the fact. The provider can see if this happens again with another message and bulk copies of it, to increase confidence in the diagnosis. So suppose the provider is willing to consider an account as a spammer probe account.

The present invention comprises a method of a provider using the knowledge that an account is a spammer probe account in any one or more of the following ways:

1. Add any domains in its received messages to an RBL, where the domains are found from the bodies of the messages. This nullifies the value of bulk copies, if the provider can then block them by finding domains in their bodies.

2. Verify if the sender field is accurate. The spammer might not bother to forge this. If so, this might give some indication to later investigation as to the spammer's whereabouts.

3. Obtain the network addresses of where the spammer is, when she connects to the provider. (For the same reason as the previous item.)

4. Manually study the messages received that have passed the provider's filters, for clues to improve the filters.

5. Suspend one or more of the steps in the filters, for incoming messages to the account. To some extent, this is mutually exclusive from the previous item. The idea here is to stop the spammer from probing the limits of the filters.

6. Close the spammer's account.

Now consider the degree of separation of two items, from each other. The concept of degree of separation was first used by Milgram. (“The Small World Problem”, Psychology Today, vol 1, 1967.) This can be applied to the case of BMEs as follows.

The present invention comprises a method of starting with a set of BMEs, A, and an item, like a user or domain, B, and finding the degree of separation of an item in A from B. This is defined as infinite for an item in A for which there is no connection, direct or indirect, to B. For an item in A, for which there are connections to B, the degree of separation is the minimum number of items linking it to B, where we start the count at 1. That is, the degree of separation is the length of the shortest path.

While degrees of separation have been measured in the prior art for various data types, the above method is specific to the context of BMEs.

The present invention comprises for a set of BMEs, the measurement of P(k) and the use of it to characterize the set, where P(k) is the probability that a node is connected to k other nodes, where the nodes can be in any of the spaces (destination, hash . . . ) recorded in a BME.

Given that from a set of BMEs, we can extract several networks, then we can compare the P(k) found from the different spaces, to see if there is any useful correlation.

For scale free networks, it has been found (“Emergence of Scaling in Random Networks” by Barabasi and Albert, Science, vol 286, p. 509, 15 Oct. 1999) that P(k)˜k**(−gamma), where gamma characterizes the network.

The present invention comprises for a set of BMEs, the measurement and use of gamma, as defined above, to characterize the set.

Of course, if the network is not scale free, then gamma is not be a useful quantity. But to the extent that a set of BMEs has a scale free network, then gamma is useful.

Define, for an arbitrary network, the clustering coefficient of node j, with k_j links, as C(j)=2*n_j/k_j*(k_j−1) where n_j is the number of links between the k_j neighbors of j. For k_j links, the maximum possible number of links between these nodes is k_j*(k_j−1)/2, so C(j) is between 0 and 1. (“Hierarchical Organization in Complex Networks” by Ravasz and Barabasi, Phys Rev E 67 (2003).) The present invention comprises for a set of BMEs, the measurement of the average clustering coefficient, as a function of the number of links, and the use of it to characterize the set, where these are found for any of the spaces recorded in a BME.

One use of this is to see if C˜1/k, where k is the number of links. If so, then this indicates a hierarchy of clusters. So any classification or grouping of the nodes might be applied to this hierarchy.

The present invention comprises a method of finding the modified degree of separation between two items in a set of BMEs, where the items are directly connected, and the modification uses, in some way, the number of BMEs or the number of messages in BMEs, linking the items, or the directionality of the links or the timing in the BMEs' messages.

Clearly, there are an infinite number of ways to do the above. But there is one way so easy to compute that we have the explicit method below.

The present invention comprises a method of finding the modified degree of separation between two items, where the items are directly connected, and the modified degree of separation is given by the reciprocal of the number of BMEs linking the items, or by the reciprocal of the total number of messages summed across the BMEs linking the items.

The present invention comprises a method of starting with a set of BMEs, A, and an item, B, from a space covered by the BMEs, and finding the modified degree of separation of items in A from B.

In the study of networks, an often useful measure is the propagation time of a message through a network. For our networks, this is different from the average time that a message might take to go from one node to another, in an underlying network. What is of interest here is some way to measure how a message, containing some idea, is replied to or re-sent by nodes (e.g. users). The utility might be to see how an advertising message, say, filters through a network, and the amount of time it takes to do so.

6.2.6 Higher Order Styles

The present invention comprises the use of any combination of the Message Styles and the styles defined hitherto in this section 6, in evaluating a set of BMEs, or users or domains or relay domains or hashes, where these latter 4 are assumed to have associated BMEs.

The evaluations may be for various purposes, including, but not limited to,

1. designating a BME as possible spam.

2. designating a BME as a newsletter.

3. designating a domain or a relay as a possible spammer domain.

4. designating a user as a possible spammer, where the user could be a sender or a recipient of messages.

5. designating a BME as a possible Phishing scam.

For example, consider what we might do to detect Phishing. In the Message Styles, we discussed how to find Phishing when we are dealing strictly at the message level. But if we have BMEs, more powerful techniques become possible.

The present invention comprises this method to detect if a given BME is Phishing:

1. The BME has HTML.

2. Optionally, there is a <form> tag. So that the reader can fill out the form and then submit it.

3. There are at least two different domains found from the body.

4. One domain is in a list of companies that may be possible victims.

5. The domain in the From line matches the previous domain.

6. If there is a form tag, the domain in the submit button of the form is not in this list of companies.

7. [Optional] Too many relays in the BME. (Phisher is trying to hide her location.)

8. [Optional] The BME has only one From line. (Well-behaved, here.)

9. [Optional] The BME has only one Subject line. (Ditto.)

10. [Optional] Is the country corresponding to the domain in the submit button different from the country that we are in?

11. [Optional] Is the submit button of a form tag using a secure protocol, like https?

12. [Optional] Does the link in the submit button contain the domain in the From line as part of the first 50 characters, say. Suppose the phisher is pretending to be goodco.com. The From line might say something like report@goodco.com. The link might say “https://www.goodco.com.398d.atestcgi-bin.sadf . . . ”. Notice what the phisher is trying to do here. If the user moves her mouse over the button, this link contents will be shown at the bottom of the browser. So it appears to a quick glance that indeed, the link is going to goodco.com. In fact, the actual domain is further to the right.

6.3 Using Styles

Here we describe several possible ways that styles can be used, different from those already described. First we define some notation.

Let S(Q)=styles of a set Q of items, where the items are anything that we can find styles of. An item might be a message, for example. Suppose we have a set of messages M={M_i|i=1, . . . , n}. Let us split M into two subsets, M=N+P, where this can be done by any means, programmatic or manual or a combination of both. Then we find S(N) and S(P). Suppose there is a subset of styles such that the values of these in S(N) are quite different from their counterparts in S(P). Then this subset and the corresponding values might be used as a characteristic of S(N), and the subset and the other values as a characteristic of S(P). We can then use these as predictors. So given a new message, we find its style, and thence use the predictors to suggest whether the message might be related to N or to P.

1. The present invention comprises of the case where M is split into N and P by manually or programmatically determining that N is bulk messages and P is not bulk messages.

2. The present invention comprises of the case where M is split into N and P by manually or programmatically determining that N is spam and P is not spam.

Now consider again M={M_i|i=1, . . . , n}. We find {S(M_i)} for all i=1, . . . , n. We can use these values to find subsets of M, based on an arbitrary combination of styles, and a choice of possible range of values of each style.

The present invention comprises the use of styles in applying new ways to measure distances between messages. This is generally useful, for it lets us investigate possible connections between messages, and hence of possible connections between their domains and their authors.

In general, there are an infinite number of ways to define a metric. (“Elementary Classical Analysis” by Marsden, Pan Macmillan 2002.) We give an example of how styles could be used in this fashion. Let us define the modified Euclidean distance between two messages, V and W asd(V,W)=sum from i=1 to m of (f_i*[S_i(V)−S_i(W)]ˆ2) where m=number of styles f_i>=0 for i=1, . . . , m. These are the weights.

S_i(x)=style i of message x, in the range [0,1].

By choosing various specific values of {f_i}, we can emphasize or deemphasize particular styles. In particular, if we set a given f_i=0, we are ignoring style i.

6.4 Styles in Other Electronic Communications Modalities

Most of our style discussion has been about the important case of email, and especially about HTML email. But many of the methods can also be applied in other ECM spaces, like Instant Messaging or SMS. Some IM implementations can display HTML, for example.

In general, whenever an ECM space lets messages have HTML, then many of the styles mentioned above can be found. Or, if the space lets messages have some type of markup language where there can be links in the messages to other locations on a network (“destinations”), then many of the methods can be applied.

For example, in the Message Styles, we mentioned that an HTML message can have random comments. This can also arise in any other markup language that allows comments to be written, and where the viewing instrument (the equivalent of a browser) does not usually show these comments. In this event, a spammer can write random comments, to make unique versions of a message. Likewise, our canonical steps can be applied to these copies, to remove comments.

7. Applying Exclude Lists (RBLs)

Suppose we are a message provider. We assume that we have built an Exclude List (RBL) of spam domains, using the techniques described earlier, or that we have obtained this from some trusted source that used the techniques. The RBL may also have additional entries found by other methods.

The RBL can optionally be used by any routing service on any of our computers. By routing service, we mean any program that routes a message. This includes, but is not limited to, aweb server, an ftp server or any other protocol level server. We also include the case of our firewall, if we have one, or our gateway computers that are connected to the outside network.

A routing service that uses the RBL can apply this to communications that it services. If a communication is not to or from an entry in the RBL, then it passes through. But if a communication IS to or from an entry in the RBL, then the service can choose to reject the communication or let it through, but optionally sample it. By the latter we mean that the service might make an internal record to indicate that it has received a communication to or from an entry in the RBL. Another reason for the service passing through the communication is that it might then optionally and algorithmically monitor it, to try to extract other domains from it.

Periodically, it might then contact its RBL source and tell it that certain domains are still actively communicating, optionally with the times/frequencies and other data about those communications. Plus it might give data on the other associated domains. This feedback mechanism to the RBL source helps the latter maintain the freshness of its entries, across the various ECM spaces, and well as pull in more entries.

A specific routing service may not be able to use an RBL, or if it can, it may only be able to accept or reject. But our above description gives incentive for a reimplementation of the routing service, either by the vendor of the current implementation or by a third party, to be able to accept, reject or sample in the manner described.

Another optional step is to pass the RBL to outside computers that often relay messages to us, and ask them to block any messages originating from the RBL's domains. This of course assumes that the owners of those computers are willing and able to do this.

A generalization of the latter step is to have a hierarchy of RBLs. For example, imagine that our company has several divisions. Each division might have its own RBL, which it sends to the top corporate level. Then a routing service at the latter might decide for an incoming communication to a given division, to apply that division's RBL against it. Clearly, if divisions have subdivisions, then this can be recursively applied downwards.

Likewise when we consider (external) relays, there could be a hierarchy of these. So a given relay might use RBLs given to it by its subrelays in a similar fashion.

8. Filtering Messages

Notice in the previous section that blocking direct communications does not prevent us from getting messages that point to domains in the RBL, because these messages can come from anywhere on the network. Thus, the rest of this section describes how we deal with this.

Optionally, we have built a table of message hashes, for messages that have been deemed to be spam. The determination of whether a message is spam may have been done through our techniques described earlier, or by any other means, or a combination of these. In any event, hashes were found for those messages, using our techniques. Let n be the number of hashes in a message. Let m be 1<=m<n and it describes how many hashes have to be the same between two messages for them to be similar.

Optionally, we have built a table of “Bad Styles”, and a minimum number, q. These is a set of styles such that if a message has q of these, then the message is probably spam.

In the description below, it should be obvious to someone skilled in the state of the art that by simple modification, the description can also be applied if we are a user in a p2p group.

Consider an incoming message M, to be sent to one of our users.

Optionally, we can compare its sender against a whitelist that the user might have. If the sender is in it, then we put M in her mailbox.

Optionally, we can compare its sender against our whitelist. If the sender is in it, then we put M in her mailbox.

Optionally, we can compare its sender against a gray list that the user might have. If the sender is in it, and, optionally, if no domains found from the body of M are in the user's list of spam domains, then we put M in her mailbox. The gray list is a list of newletters and other bulk mail senders that she want to get.

Optionally, we can compare its sender against our gray list. This is a list of newletters and other bulk mail senders that we permit our users to get, by default. If the sender is in it, and, optionally, if no domains found from the body of M are in the RBL, then we put M in her mailbox.

Optionally, we can compare its sender against a blacklist that the user might have. If the sender is in it, then we reject M.

Optionally, we can compare its sender against our blacklist. If the sender is in it, then we reject M.

A gray list is a novelty we introduce. Prior to our method, if a user had a whitelist, she would put the addresses of people she corresponds with, and also of any newsletters that she subscribes to. The problem with a whitelist is that it is cumbersome to maintain. Often, this maintenance has to be manual. If so, the typing of another person's address can be error prone. And if it is a strict whitelist, so that only users on it can get through to her, then mistyping will prevent that. The biggest problem is simply how does another user who has never contacted her before do so? Challenge-response methods attempt to answer this, by temporarily holding a message from an unknown user, while sending a challenge and expecting a correct response, in order to forward the message to the recipient. Some senders will not respond correctly to a question posed in the challenge. Others will refuse to do so, thinking this is a waste of their time. Still others will not be logged in when they get the challenge. Or might log in after it has expired. (Challenges often have an expiration date.) Or, if they log in before expiration and answer correctly, the original message can get considerably delayed.

Our gray list obviates all this. Our method objectively detects bulk mail, which is spam plus newsletters. It is possible to block all detected bulk mail. But what if a user subscribes to some newsletters? She just puts these into her gray list. Typically, the number of newsletters that any user subscribes to is fairly small, safely less than 50, and probably less than 20. Think of this as exception processing, which should be rare, and it is, in this case. Whereas in a whitelist that has people that she corresponds with, it could run into the hundreds of entries.

A utility of the gray list is that it can be used, optionally in place of one or both of a whitelist and of a blacklist. (Though the latter two can still be used.) Messages from a user's correspondents should not be bulk, presumably. These will be let through by our method. So not having to maintain a whitelist will be far easier for users. Plus, it avoids all the disadvantages of using a challenge-response method.

Nor does a blacklist of spammers need to be maintained. Because our method can detect these. And a blacklist applied against a sender line is largely useless against spammers who forge this line, anyway. A user may still want to maintain a shorter blacklist; restricted to non-spammers that the user does not want messages from.

Notice that above, when we use a gray list against the sender data, we allow the possibility of checking the body's domains against a list of spammers. This prevents spammers from pretending to be an existing newsletter.

Optionally, we can compare the sender domain against a local set of spam domains that the user might have. If it is present, then we reject the message. While many spammers forge the sender address, some do not. So it helps to make this simple test, to filter those out. The assumption here is that who would forge a sender address, claiming to be a spammer? Optionally, we can compare the sender domain against our RBL. If it is present, then we reject the message.

From M, we find the list of link domains in its body. This technique was described in the section on canonical reduction. Suppose the body has these domains; call this set D. If the user has a local set of domains that we consider spammers, and if any member of D is in this set, then we reject M as spam, or, optionally, we deliver it to her, marked in some fashion. For example, we could write a header indicating that the message is suspected spam. Or we could write it to a different mailbox for that user.

Otherwise, if any member of D is in our RBL, then we reject M as spam, or, optionally, we deliver it to her, marked in some fashion.

Typically, an RBL is used in the prior art to just compare against the sender's domain in the From line. But since many spammers forge this line, it is of limited utility. A novelty we offer above, is that we apply the RBL against the domains extracted from M's body. This is of far greater efficacy than, say, another method which extracts entire link URLs from spam and compares those against URLs found in M. As we explained in our section on the canonical process, comparing URLs is brittle, because a spammer can easily make new unique URLs.

Optionally, we can compare the relays in M's header to a local set of spam domains that the user might have. If a relay is in the set, then we reject the message.

Optionally, we can compare the relays in M's header to our RBL. If a relay is in the RBL, then we reject the message.

Optionally, we apply this rule based processing step. We find hashes from M. Then we compare M with our table of (spam) message hashes. If M is canonically equal to a message in this table, then we either reject M or we deliver it to the user, marked in some fashion. If we are still considering M, then we check if M is similar to any message in the table. If so, then we either reject M or we deliver it to the user, marked in some fashion.

Optionally, we apply this rule based processing step. It assumes that we did the previous optional step of finding hashes. In doing so, we found various styles for M. If the user has a Bad Style table, then we check M's styles against it. If M has y or more styles in the table, where y is chosen by the user, then M is considered spam, and we either reject it or deliver it to the user, marked in some fashion. If we are still considering M, then we check it against our Bad Style table. If M has more than q styles in this table, then M is considered spam, and we either reject it or deliver it to the user, marked in some fashion.

Optionally, we can use Bayesian filters against M. These may be language dependent.

Optionally, we can use top analysis against M.

Optionally, we can use linguistic analysis against M.

Optionally, we can use other rule based processing against M.

Optionally, we can use any other relevant filters against M.

9. Building an Advanced Statistical Categorization Filter

Statistical filters, Bayesian and otherwise, have suffered from a number of limitations that beggar their utility.

1) Incremental Broadening—Incremental broadening of spam identifiers occurs via two primary sources—a) An individual classifies as “spam” a broad set of email that crosses numerous interest categories. This causes the statistical functions to associate a number of “innocent” words into the “indicative of spam” classification. This in turn generates false positives in the spam identification process b) A filter attempts to serve too many masters; i.e., an ISP tries to utilize a statistical filter at the server level. Trying to identify spam in a communications feed Both/either of these processes can cause a broadening of the statistical filter that makes the results highly suspect. Even if we maintain a weighted filter per email user, there is still a need to regularly manage the tokens, values, or words considered to be indicative of spam. This involves a good deal of work per user; additionally, the most effective management of these tokens is done by the individual users themselves. A central administrator cannot know what kinds of email each user is comfortable with.

2) Intentional Poisoning—Including random emails, collections of random words, and/or collections of random sentences and paragraphs into the spam corpus. These active countermeasures by spammers lead to rapid, large-scale broadening of the statistical model.

Intentional poisoning is similar to Incremental Broadening except that the broadening is induced specifically to cause false positives in spam classification. This type of behavior by spammers can increase the management requirements of the statistical filters many-fold. For this reason few people have been willing to use a Bayesian, or other statistical filter, for long term spam classification in large user bases.

Our ability to group messages into BMEs and thence derive Exclude Lists (RBLs) and apply these against incoming messages, and the ability for each user to have a gray list of bulk senders that the user is willing to accept messages from, gives us several ways to minimize the above limitations.

Suppose a user maintains a Bayesian or other statistical filter specific to her interests. The limitations above are due to the broadening of the filter. In large part, this is due to too many messages getting to her, that she then determines to be spam, and sends to her filter. Our ability to prevent unwanted bulk messages reaching her helps immensely. There is far less contamination and broadening of her filter, in any given time interval, as compared to what would happen if our methods were not used. A second advantage is that she has less manual effort in that time interval, to send any messages she considers spam to her filter.

Plus, even if eventually the filter broadens sufficiently so that it has to be reset, this would be at a lower frequency than without our methods. Which is another diminishing of manual effort.

The above filter acts as a reject filter. A user might also maintain an accept filter, in place of or in addition to a reject filter. The accept filter would be trained on messages that she does not consider to be spam. Without our methods, maintaining the accept filter might require the same manual effort needed to maintain a reject filter. But with our methods, having less spam to manually detect, after it has passed through all the filters, means a similar reduction in effort to send non-spam messages to the accept filter.

The message provider also has the ability to make advanced statistical categorization filters, based on the incoming or outgoing messages or both. Being able to make BMEs, where these have values in various metadata spaces, like domains, hashes, styles, relays and users, means that provider can choose a subset of BMEs, based on any combination of values in those spaces, and thence train a filter with this subset, or apply a filter to the subset.

For example, imagine picking a set to be those BMEs where each BME has a style of several senders and a style of several subjects. From our earlier discussion, each of these styles is highly indicative of spam, and each is unique to our methods, because they require the construction of a BME. Given this set, the provider might train a filter with it. And perhaps train another instance of the filter, with messages not in the set. By comparing the resultant instances of the filter, the provider can investigate the existence of possible common features amongst the messages/BMEs in the spam set. An intent might be to enhance the efficacy of the filter by searching for those common features in future messages.

Our discussion here of a message provider making advanced filters also applies to a group of users who band together in a p2p fashion to perform message analysis.

10. Algorithmic Adaptive Real Time Black Lists

We describe how to algorithmically build and manage an adaptive real time black list, as derived from and applied to electronic communications. We process a set of messages and construct BMEs. We can determine relationships between the elements in a defined metadata space of the BMEs, or correlate groups of elements across these various defined spaces. Additionally, we can cross-correlate various communications spaces from disparate sources. This cross-ECM analysis permits the refinement of our understanding of some or all of the ECM spaces involved. If we have multiple information sources related to the spatial domain of interest, we can verify various properties and attributes of that space.

We use an example of email, but our methods are generally applicable to other electronic communications.

Below, we refer to a Bulk Link Envelope (BLE). This is analogous to a BME. A BLE summarizes information about a domain. If there are web pages at the domain, various heuristic analysis might be performed on those pages and the results put into the BLE. It might also have the ICANN information above.

In the case of email we have three canonical domain information sources available to us:

1. email derived domain information

2. custom web crawler information of the email derived domains, and their page derived linked domains

3. Information from official registries such as the Internet Corporation for Assigned Names and Numbers (ICANN) and authorized registries for .com, .org, .net, .info, .name, etc that are appropriate to the domains under consideration

Given these sources, we can perform any or all of the following actions algorithmically (including, but not limited to):

1. Extract the body link domains and determine clustering (using an exclude list)a. Determine clustering by domain names and IP address

2. Extract Sender domain(s) from the BME

3. Extract and validate the Relay chain(s) from the BME

a. (For example, if a relay is an invalid domain or IP, this suggests that the sender is writing false relay information to hide his trail.)

b. (For example, if several canonically identical messages have the same body link domains, but different relay chains, this suggests that the sender is writing false relay information to hide his trail.)

4. Find users related to various message clusters and/or spammer clusters (mailing list clusters)

5. Perform the advanced statistical methods on messages and BMEs, as described in the previous section.

6, Do various “reality checks” on the domains (including, but not limited to)

a. Do canonically identical messages in BME refer to different body link domains? (If so, this is typical of a spam message sent out by several associated spammers, who start with an original message and put in links to their own domains.)

b. Do sender domain(s) from BME correspond to body link domains? (If not, then this is common in spam, where the spammer writes a false sender domain, to mislead antispam software that just blocks against a list of spammer sender domains.)

c. Do sender domain(s) from BME correspond to relay chain(s)?

d. Do relay chain(s) correspond to body link domains?

7. Web crawl the website(s) links in the BME to some specified depth (using exclude list)

8. Find the site heuristics appropriate from these link domains, including but not limited to the following:

a. Number of pages at each depth

b. heuristics of the various pages

c. links to other web sites,

d. build Bulk Link Envelopes (BLE) using the previous data

e. determine BLE multiplicities

9. Perform the advanced statistical methods in the previous section on pages, heuristic attributes, and BLEs

10. Find connectivity, topology, and multiplicity of domains in the BLE space(s)

11. Find the Relative Link Weightings between the BME body link domains and BLE domains

a. If enough web crawler data exists, calculate relative relationship rankings for domains

12. Extract all relevant data from various official registries (DNS, WHOIS, etc) for domains

a. NSP

b. ISP

c. Hosting Agent

d. Ownership (purported)

e. Contacts for the various purposes (purported)

f. email relays associated with Owner, Host, ISP or NSP

g. IP address(es) associated with domain via these or other indices

13. Perform cluster analysis, and cross reference “registry space(s)” with other data spaces.

Once we have determined a candidate domain or set of domains for a black list, we use the data from the other two canonical data spaces to “verify” and “clean” the candidate set. Once we have run all of the correlations and checks of interest, the resultant set of domain names and/or IP addresses can be output in the form of a black list. (We call this a black list, but it could be used to select messages for inclusion, or to promote them for special processing.) We can present the candidate RBL to an administrator to optionally edit (add, enhance or delete entries) by using internally extracted and extended data sets available in regards to the domain informations; including, but not limited to:

a. Existing RBL(s)

b. Relay paths

c. From signatures

d. Domain Clusters

e. Domain Near Field Info

f. Who is info & owner/host related domains

g. DNS info & owner/host related domains

h. Name server lookup information & owner/host related domains

i. Redirection Paths

j. IP spatial clustering

k. IP-space Near Field Info

l. Hosting Information

m. Bayesian/Word frequency/Dictionary specific Analysis of spider-crawled domains

With these correlations we can achieve several communications management goals: classification, categorization, routing disposition, in depth analysis of the communications streams, etc. For email, as an example of one type of communications space, one could perform various actions (including, but not limited to) the following:

a) Find domains that issue unsolicited bulk email (spam) and thence block incoming email from or referring to those domains.

b) Block all incoming or outgoing electronic communications related to these domains (ping, ftp, http, etc), typically at the mail relay and/or firewall levels.

All of the techniques described herein are applicable to many related communications spaces; including, but not limited to:

a. E-mail and related services

b. Small Message Services (SMS), alphanumeric paging systems, and similar technologies

c. i-Mode, m-Mode, various “rich” messaging services for mobile devices, etc.

d. Instant Messaging (IM) services, and similar technologies

e. digital fax services (corporate fax servers, etc)

f. Unsolicited telephone communications management

g. archives of electronic communications

h. DNS name resolution services, and variants

i. LDAP directory management services and variants

g. jHTTP, web services and variants

h. kFTP, file transfer services and variants

11. Adaptive Hashing

An Adaptive Hashing System (AHS) comprises a comparison of two data sets, without regard to the contents of those datasets. Specifically, to determine the amount of similarity between the two data sets; by a comparison of some number of subsets of the data set. (It should be noted that this approach has no language dependency.) An AHS may compare the data sets in any manner that allows the exact determination of the equality of the two values being compared. The AHS may compare the actual values, or any sufficiently unique representation of those values. The sufficiently unique requirement means that any representation used must satisfy this: the odds of any two data, that are not identical, mapping the to same representation value should be vanishingly small.

In the present implementation we have used SHA-1 for these important reasons:

1. This function meets the sufficient uniqueness requirement.

2. Ease of use But any representation function that meets the sufficient uniqueness requirement is acceptable.

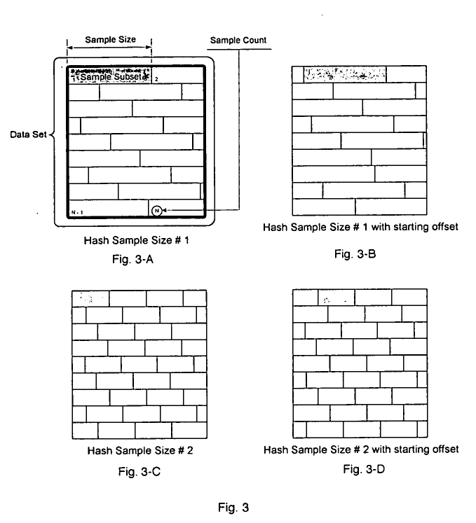

An AHS may choose to subdivide the data set into sample subsets, as shown in FIG. 3. The sample subsets should encompass a significant fraction of the data set. The sampling may be done in any fashion as long as the process is deterministic. To meet this deterministic sampling requirement this must be true: Any two processes sampling the same data set must arrive at the identical group of data subsets.

The sample size of the subsets may be a fixed value, or it may be algorithmically determined as a function of any combination of, but not limited to, the following:

1. data set size

2. preferred average sample size

3. preferred minimum sample size

4. preferred maximum sample size

5. preferred average number of samples

6. preferred minimum number of samples

7. preferred maximum number of samples

8. thoroughness of matching9.computational requirements

In our description below, we use these values of interest:

1. Default Hash Sample Size (DefaultHashSize)

2. Default # of Hashes allowed (DefaultHashCount)

3. Minimum Hash Sample Size (MinHashSize)

4. Maximum Hash Sample Size (MaxHashSize)

5. Minimum # of Hashes allowed (MinHashCount)

6. Maximum # of Hashes allowed (MaxHashCount)

7. Algorithmically Selected Hash Sample Size (CompHashSize)

8. Algorithmically Selected Number of Hashes (CompHashCount)

To compensate for the variable size of messages, an AHS may:

Optionally, let MinHashSize and/or MinHashCount vary algorithmically with constraints at very small message bodies.

Optionally, let MaxHashSize and/or MaxHashCount vary algorithmically with constraints at very large message bodies.

To compensate for random data variations in the data set, an AHS may:

Optionally, sample the data set at multiple sample sizes.

Optionally, sample the data set at multiple starting offsets.

Optionally, sample the data set at multiple samples sizes & multiple starting offsets for each sample size. An AHS may flatten to a basal similarity map, which is a map of all sections/characters of a dataset that have been matched via all sample size and starting offset combinations.

Also, an AHS may compute a plurality of hash sizes and multiple starting offsets for each sample size, to determine the level of random variation in a pool, group, or set of messages. These informations are ascertained by measuring the occurrences of differential match coverage of the data set by samples at the same hash size but different starting offsets, and/or by samples at different hash sizes with overlapping partial coverage map, and/or by other relative informations. This lets the system measure the gross amount of random variation in the communications stream.

In our present implementation we use a selection process similar to the process as follows, where we choose the hash sample size by these steps:

1. Based on a initialization value, or by other means, we either

1.1 compute CompHashSize and/or CompHashCount

1.2 use the DefaultHashSize as the hash sample rate

1.3 or use the preset DefaultHashCount.

2. If we are computing CompHashSize and/or CompHashCount

2.1 Let CompHashSize=MinHashSize.

2.2 Divide the size of the canonically reduced message body by CompHashSize to get a provisional hash count, CompHashCount.

2.3 If CompHashCount>=MinHashCount and CompHashCount<=MaxHashCount, then the value of CompHashSize is acceptable and we go to step 4.

2.4 Else if CompHashCount<MinHashCount then CompHashSize=MinHashSize is acceptable

2.4.1 Invoke small message body handling rules.

2.4.2 Divide the size of the canonically reduced message body by CompHashSize to get CompHashCount

2.4.3 Go to step 4

2.5 Else if CompHashCount>MaxHashCount then increment CompHashSize

2.6 If CompHashSize>MaxHashSize, then CompHashSize=MaxHashSize.

2.6.1 Invoke large message body handling rules.

2.6.2 Divide the size of the canonically reduced message body by CompHashSize to get CompHashCount

2.6.3 Go to step 4

3. If we are using DefaultHashSize and/or DefaultHashCount then go to step 4.

4. Sample data at the chosen hash size and/or hash count

The small and large message body handling rules referred to above handle the respective special cases. The instantiation of these rules can be chosen by the user, with optional setting of styles to designate that these cases have occurred during hashing.

An example of a rule might be that if a small message body situation is detected, then we do not make any hashes, and we set a style to indicate this. Here, the size below which a message body is considered to be “small” is a parameter that can be set by the user.

An example of a rule might be that if a large message body situation is detected, then we do not make any hashes, and we set a style to indicate this. Here, the size above which a message body is considered to be “large” is a parameter that can be set by the user. We might not make any hashes in this case because of overly large computational effort.

12. System Implementation

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

Basic elements of a digital computer include a processor, for processing machine language digital data, and a memory. In general, machine language instructions for controlling processing operations of the processor are stored in memory. Memory may also contain at least portions of data to be processed. Instructions and data are transmitted between processor and memory by memory input and output busses. A computer further includes input/output (I/O) apparatus for transmitting instructions and data between computer and external devices. External devices may include, e.g., a control console or an attached storage units.

1. A method for processing digital messages on an electronic communication system, each message having a header and a body, comprising: identifying a set of characteristics of a first message, the set including; addresses extracted from the header and body of the message; and a condensed representation of the message body produced by: eliminating message content not perceptible in the normal display mode of the message; converting the perceptible message content to a standardized format characterized by limited degeneracy; generating a plurality of hash values which represents the converted content of the message body; storing the set of identified characteristics of the first message in a first bulk message envelope, the first bulk message envelope including a frequency index; identifying the same set of characteristics of a second message; comparing the set of identified characteristics of the second message to the first bulk message envelope; upon determining that the second message has characteristics dissimilar to those of the first bulk message envelope, storing the set of identified characteristics of the second message in a second bulk message envelope, the second bulk message envelope including a frequency index with a unitary value; upon determining that the second message has characteristics similar to those of the first bulk message envelope, increasing the frequency index of the first bulk message envelope by a unitary increment.

2. The method of claim 1, further comprising:
identifying the same set of characteristics of a third message;
comparing the set of identified characteristics of the third message to the first and second bulk message envelopes;
upon determining that the third message has characteristics similar to those of either the first or second bulk message envelopes, increasing the frequency index of the most similar bulk message envelope by a unitary increment;
upon determining that the third message has characteristics dissimilar to those of the first and second bulk message envelopes, storing the set of identified characteristics of the third message in a third bulk message envelope, the third bulk message envelope including a frequency index with a unitary value.

3. The method of claim 1 in which the step of identifying the characteristics of each message comprises:
transforming the message to a reduced format; processing the reduced message to derive a condensed representation of the reduced message.

4. The method of claim 3 in which the condensed representation comprises plural hashes.

5. The method of claim 3 in which the step of transforming the body to a reduced format comprises:
eliminating non-communicative information from the message.

6. The method of claim 3 in which the step of translating the body to a reduced format comprises:
conforming communicative information in the message to a standardized format characterized by limited redundancy.

7. The method of claim 3 in which the step of translating the body to a reduced format comprises:
eliminating address information from the message.

8. The method of claim 1 in which a set of characteristics of each message comprises:
address data associated with the message.

9. The method of claim 8 in which the address data comprises:
the purported originating address of the message.

10. The method of claim 8 in which the address data comprises:
one or more addresses included in the body of the message.

11. The method of claim 8 in which the address data comprises:
one or more addresses through which the message has purportedly been relayed.

12. An electronic communication system comprising interconnected entities for transmission and receipt of messages, the system comprising, in at least one of said entities, a subsystem for processing messages comprising:
a unit which identifies a set of characteristics of a message; a memory which stores the set of identified characteristics of messages in a plurality of bulk message envelopes, each bulk message envelope including a frequency index; a unit which compares the set of identified characteristics of a message to the bulk message envelopes, and if the identified characteristics are similar to a stored bulk message envelope, increasing the frequency index of the bulk message envelope in response, and if the identified characteristics are dissimilar to any stored bulk message envelope, causing the set of identified characteristics to be stored in the memory as an additional bulk message envelope.

13. A computer program embodied on a computer-readable medium and/or memory device for providing a subsystem for processing messages comprising:
an identification segment for extracting a set of characteristics of a message; a storage segment for storing the set of identified characteristics of a message in a bulk message envelope, each bulk message envelope including a frequency index; a comparison segment for comparing the set of identified characteristics of a message to the bulk message envelopes, and if the identified characteristics are similar to a stored bulk message envelope, increasing the frequency index of the bulk message envelope by a unitary increment, and if the identified characteristics are dissimilar to any stored bulk message envelope, causing the set of identified characteristics to be stored in the memory as an additional bulk message envelope having a frequency index with a unitary value.

14. An article of manufacture comprising:
a machine readable medium and/or memory device that provides instructions that, if executed by a machine operatively connected to an electronic messaging system, will cause the machine to perform operations including:
identifying a set of characteristics of a first message;
storing the set of identified characteristics of the first message in a first bulk message envelope, the first bulk message envelope including a frequency index; identifying the same set of characteristics of a second message;
comparing the set of identified characteristics of the second message to the first bulk message envelope;
upon determining that the second message has characteristics similar to those of the first bulk message envelope, increasing the frequency index of the first bulk message envelope by a unitary value; upon determining that the second message has characteristics dissimilar to those of the first bulk message envelope, storing the set of identified characteristics of the second message in a second bulk message envelope, the second bulk message envelope including a frequency index with a unitary value.

15. The method of claim 3 in which a set of characteristics of a bulk message envelope include heuristic properties relating to the formatting or presentation of the data in the messages.

16. The method of claim 3 in which from a set of bulk message envelopes thusly made, and using various characteristics of these, a real time black list (RBL) of spammer domains are derived.

17. The method of claim 16 in which the RBL is applied against the current set of messages, possibly with a delay to detect and block current types of unwanted messages, or against a new set of messages, to block unwanted messages.

18. QuickMarkQuickMark The method of claim 16 in which the RBL is used by various routing services or gateways or relay machines to block communications with entries in the RBL.

19. The method of claim 3 in which a user can maintain a “gray list” of desired bulk message senders, and the user's message provider uses claim 3 to find bulk messages addressed to the user, and from these bulk messages, forwards only those from senders on the gray list, to the user, where the determination of the sender of a message may involve examining the contents of a message, in addition to examining the purported sender field and other entries in the header.

20. The method of claim 4 in which these plural hashes may be exchanged by different organizations or users to detect messages seen by others, in an anonymous query manner that preserves the privacy of the original messages.

21. The method of claim 4 in which these plural hashes may be found in an adaptive hashing manner.

22. The method of claim 3 in which the subsets of the bulk message envelopes are chosen, to which further filtering is applied; where the filtering might include Bayesian, neural network or other techniques, some of which are possibly dependent on human languages; where the subsets may be derived using various values of the bulk message envelopes, including, but not limited to, the frequency of each envelope.

23. The method of claim 3 in which the bulk message envelopes found from messages in one electronic communication space are used to compare and correlate with those derived from messages or data in another electronic communication space.
